(19) United States
(12) Patent Application Publication
(10) Pub. No.: US 2007/0036686 A1
(43) Pub. Date: Feb. 15, 2007

(54) Systems for tracking and testing of medical specimens and data

(76) Inventors: Mehdi Hatamian, Coto de Caza, CA (US); Mehrtosh Ghalebi, Rancho Santa Margarita, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/444,902

(22) Filed: May 31, 2006

Related U.S. Application Data
(60) Provisional application No. 60/686,269, filed on May 31, 2005.

(51) Int. Cl. B01L 3/00

(52) U.S. Cl. 422/102

(57) ABSTRACT

The disclosed inventions provide for improvements to data storage that is integral to sample containers such as test tubes. Systems and methods for enclosing radio frequency read/writeable chips within sample containers are described, as well as systems and methods for gathering data to be stored. Examples of useful medical contexts for the technology are presented, including for physician and lab blood testing data. Some embodiments disclose systems and methods that can track data and process samples with the help of a portable unit. Some embodiments of the portable units not only assist in entering, storing, and transmitting medical data, they also comprise novel systems that can process and or analyze whole blood. Accordingly, centrifuge portions are described, including two novel types of test tube valves that function in concert with the described centrifuge portions.

### PRIORITY CLAIM

This application claims the benefit of U.S. Provisional Patent Application No. 60/686,269, entitled SYSTEMS FOR TRACKING AND TESTING OF MEDICAL SPECIMENS AND DATA, filed May 31, 2005, the entirety of which is hereby incorporated by reference herein and made part of this specification.

### BACKGROUND OF THE INVENTIONS

1. Field of the Inventions

The inventions relate generally to systems for obtaining and organizing information, and particularly to systems for the tracking and testing of medical specimens.

2. Description of the Related Art

The medical diagnosis process often involves obtaining and testing specimens from a patient's body. In many cases, such specimens are bodily fluids from a patient, such as blood. On a daily basis, vast quantities of such specimens are taken from patients and tested by physicians or laboratories to assess characteristics of those specimens. The testing is generally performed in parallel with the testing of other specimens taken from many other patients, and a wide array of potential tests can be performed on any given specimen. This results in a complicated process for obtaining and storing patient and test information. In the systems currently in use, there are many instances of repetitive human labor and potential for human error in the data input and tracking processes. Moreover, certain inefficiencies in existing systems increase the time it takes for a test to be performed and for the information to be relayed back to the physician and patient. Such problems are especially prominent in the treatment of urgent care patients, particularly those who are being treated by first responders, such as paramedics. However, even routine testing can be error prone because of risk factors such as human fatigue, human laziness, equipment failure, lack of reliable quality control, lack of back-up systems, etc. In attempting to cut health care costs, institutional pressures may also increase the need for diminished reliance on human labor.

In the current system used for tracking and testing specimens of patients' blood, the same data entry tasks are frequently performed at the doctor's office and again at a laboratory testing facility. Such redundant data entry increases the human labor cost, the potential for error, and the time necessary to return the test results. Although the cost of such inefficiencies and the potential for error may be relatively low on any given sample, millions of such tests are performed on an annual basis and increased efficiencies can save significant resources and avoid serious mistakes.

The procedure for processing a typical blood test provides an instructive example. In preparation for performing blood tests, a doctor's office typically obtains a supply of test tubes with color-coded silicone caps. Each color coded test tube cap refers to particular types of tests that can be performed on a blood sample to be inserted into that test tube. In many circumstances, the test tube also includes particular reagents that need to be combined with the blood of the sample when the sample is inserted into the test tube. A healthcare professional withdraws the blood from a patient and inserts the blood into the test tube. The healthcare professional refers to a pamphlet or book listing codes associated with various types of tests that can be performed on blood, and then writes down on the printed form the particular code relating to the test or tests desired to be performed on that specific blood sample. A technician in the physician's office may also perform certain steps to condition the blood before it is transported, such as spinning it in a centrifuge or adding reagents.

The healthcare professional then obtains a printed form, fills in information relating to the patient and the test to be performed on the blood, puts the cap on the test tube, and then physically attaches the filled-out printed form to the test tube, such as with a rubber band. The sealed test tube and form are generally placed in a sealed bag with a label and then stored in an area of the doctor's office with other samples. A courier gathers multiple samples, sometimes from multiple health care facilities, and transports them to a laboratory for testing.

After the courier delivers a collection of blood samples to the laboratory, a technician at the laboratory generally opens all the sealed bags at once, places all of the test tubes in holders, and places all the forms in a pile. The technician then picks up each form, one by one, associates it with the related test tube, enters the handwritten data from the physician's office into a computer, prints out a bar code, and affixes the bar code to the test tube. Thus, the step of recording the patient's information, and the type of blood test or tests has been performed at least twice, duplicating the human labor involved and increasing the potential for mistake. During the process of sorting through the forms and tubes upon arrival at the laboratory, technicians sometimes notice that a form in one or more bags indicates a test to be performed on a particular test tube that does not match the color of the cap on the tube. At that point, the lab technician must contact the physician's office and resolve the error. In some instances, to minimize the risk of a mistake, the patient must return to the physician's office and have the sample blood drawn again. Even worse, if a mismatched sample is not identified and corrected, an error in the reporting of the test can lead to misdiagnosis. Many testing laboratories process great numbers of samples each day, and the logistics associated with data entry and tracking present significant challenges. With the greater numbers, of course, comes an increase in the potential for errors.

After the data has been re-entered and the bar code has been affixed to the test tube, the specimens are dispersed to various locations in the lab for the necessary testing. In various stages of sorting, storing, and transporting the specimens during the testing procedures, an optical reader scans the bar code sticker and determines what treatment will be applied to the sample and what data will be reported about the sample to the physician and the patient. In some cases, multiple bar code stickers are applied to a given sample, especially when multiple tests will be performed on the same sample. The optical reading procedure is vulnerable to various inefficiencies and mistakes. In some cases, the bar code is damaged or removed. In some cases, only one of multiple bar codes may be read. Also, the bar code may be smeared, crumpled up, or otherwise rendered unreadable. In addition, because accurate reading requires an optical reader to have a particular orientation with respect to the bar code sticker, human labor and/or complicated mechanical sorting equipment may be required.

In the current system for collecting and storing blood specimens, certain constituents of the blood are often physically separated, such as by using a centrifuge, so that specific tests can be performed on different constituents. Unless the constituents are separated by a physical barrier after a centrifuge process, they will often recombine within the test tube over time. In the current system, test tubes are prepared in advance for a specific type of test by including a particular reagent and/or preservative in the test tube along with a certain amount of waxy material with a known specific gravity that automatically forms a barrier between the blood constituents desired to be separated during a centrifuge process. However, the waxy material sometimes reacts in an adverse manner with the reagents or other items in the test tube. Materials in the wax can be biologically active over time. Furthermore, the wax barrier between blood constituents can sometimes be breached. Thus, there is a need for an improved means for maintaining the physical separation of blood constituents that does not affect the testing of the sample.

After the test is performed on a particular sample of blood, the test results are recorded in a computer system or on a paper form, and transmitted back to the physician's office generally by a telephone call, fax, or on a form returned by the courier on a trip back to the physician's office to collect new samples. At the physician's office, the data is generally included in a physical printed file, and sometimes also entered into a computer system.

The examples above describe typical blood testing during standard health care treatment, where lab and/or testing facilities can be located remotely from the health care provider. However, emergency situations present additional challenges. Paramedics or other healthcare professionals often need to know information about a patient immediately to ensure that the proper treatment is given and, if necessary, to protect against the spread of infection to others. In this circumstance, the redundancy and risk of error associated with processing multiple samples and test results by physicians and laboratories is not the primary concern. Rather, the need for rapid and accurate test results on a sample is paramount. In such emergencies, there is no time for transporting a sample to a laboratory and waiting for a sample to be tested in a large batch with many other samples, and mechanical processing of the blood is not available to emergency healthcare professionals in the field.

In emergency response situations, as in all medical treatments, the data associated with a given specimen and the test results need to be correlated with the patient from whom the specimen was taken. In the haste of an emergency medical procedure, the risk of erroneous data entry or tracking is increased. Moreover, persons who are being treated in emergency situations frequently are not coherent or conscious, and their identity may not even be known, making it more difficult to correlate specimen test results with such an individual. Such challenges are intensified in emergency situations involving large numbers of victims or in battle.

Thus, there is a need to improve the speed and accuracy of such data gathering and processing in the context of both standard care and urgent care settings to minimize the risk of errors, improve efficiency, and increase the effectiveness of patient treatment.

### SUMMARY OF THE INVENTIONS

The disclosed inventions provide for improvements to data storage that is integral to sample containers such as test tubes. Systems and methods for enclosing radio frequency read/writeable chips within sample containers are described, as well as systems and methods for gathering data to be stored. Examples of useful medical contexts for the technology are presented, including for physician and lab blood testing data. Some embodiments disclose systems and methods that can track data and process samples with the help of a portable unit. Some embodiments of the portable units not only assist in entering, storing, and transmitting medical data, they also comprise novel systems that can process and or analyze whole blood. Accordingly, centrifuge portions are described, including two novel types of test tube valves that function in concert with the described centrifuge portions.

In some embodiments, there is provided a system for tracking a sample. The system can comprise a test tube having having a cylindrical portion and a rounded bottom portion. The test tube can further comprise a top end configured for allowing sample insertion into an interior cavity and a bottom end having a chamber separated from the interior cavity. The chamber can be closed with a cap that forms a rounded end portion of the outer contour of the rounded bottom portion. The test tube can further comprise a radio-frequency identification (RFID) chip within said chamber. The test tube can further comprise a read-write device having a receptacle for said test tube and a read-write element, the receptacle configured to position the RFID chip within range of the read-write element.

In some embodiments, there is provided a method of manufacturing a sample container in the shape of a standard test tube. The method can comprise: providing a plastic material; forming the plastic material in the general shape of a test tube with an open end that opens into a sample-containing portion, a closed end, and a chamber portion at the closed end, the chamber portion not open to the sample-containing portion; inserting an RFID chip into the chamber portion; and covering the chamber portion with a plastic cover that provides a rounded bottom end on the test tube.

In some embodiments, there is provided a method of gathering information related to a medical specimen. The method can comprise: providing a portable device that comprises a centrifuge and a computer; entering victim and/or incident information into the portable device; obtaining a biological sample from the victim and placing the sample in a sample container comprising an electronic data storage device; processing the sample with the portable device; and using the portable device to write electronic data to the electronic data storage device.

In some embodiments, there is provided a device for processing samples. The device can comprise: a computer having a user interface, the user interface comprising a data input device and a data projection device; a centrifuge; a sample holder; and a wireless signal transmission/reception module.

In some embodiments, there is provided a tilt valve comprising: a first valve portion with an insert stem having a first length and a first contacting portion that is wider than the insert stem; and a second valve portion with a receiving stem having a second length, the second length greater than or equal to the first length, and a second contacting portion having approximately the same width as the first contacting portion.

In some embodiments, there is provided a method of separating fluid components with a tilt valve. The method can comprise: providing a test tube having side walls; providing a fluid with components of different densities within the test tube; providing a tilt valve within the test tube; providing a centrifuge; and causing the tilt valve to assume an open position by rotating the test tube in the centrifuge.

### BRIEF DESCRIPTION OF THE DRAWINGS

Certain embodiments of the inventions will now be briefly described with reference to the drawings. These are illustrative examples, and the inventions are not limited to the subject matter shown or described.

FIG. 1 is a schematic diagram of a sample container, such as a medical specimen container, with an integral data storage device.

FIG. 2A is an inverted perspective view of a test tube with a data storage chip.

FIG. 2B is an exploded perspective view of the test tube of FIG. 2A.

FIG. 2C is a schematic cross-sectional view of a test tube with a data storage chip with a similar configuration to the test tube of FIG. 2A.

FIG. 3A is a schematic illustration of a data read/write device attached to a computer for data input, processing, and storage.

FIG. 3B is a perspective, partial cut-away view of the data read/write device and test tube of FIG. 3A.

FIG. 4A is a schematic flow chart of the steps that can be performed when a medical specimen is inserted in a test tube and data about the specimen is recorded on an integral data storage device.

FIG. 4B is a schematic flow chart illustrating certain steps involved in entering data, processing such data, tracking medical specimens, and reporting test results relating to such specimens.

FIGS. 5A-5L illustrate various views of an embodiment of a graphical user interface for entering data into and/or obtaining data from a computer system configured to receive and process data relating to a patient and/or specimen.

FIGS. 6A-6F illustrate various views of another embodiment of a graphical user interface for entering data into and/or obtaining data from a computer system configured to receive and process data relating to a patient and/or specimen.

FIG. 7 is a schematic illustration certain components included in some embodiments of a portable device for testing and tracking medical specimens.

FIG. 8A is a perspective view of one embodiment of a portable device for testing and tracking medical specimens and/or medical information.

FIG. 8B is an illustration of the device of FIG. 8A with a test tube poised for insertion in the device, a centrifuge lid open, and a removable module in a removed position.

FIG. 9 is an illustration of the underside of a removable module.

FIG. 10 is a perspective view of the centrifuge device that can be used in the portable testing and tracking device of FIG. 8, with a test tube poised for insertion.

FIG. 11A is a perspective view of the centrifuge motor housing that can be used to mount the centrifuge of FIG. 10.

FIG. 11B is a perspective view of the opposite side of the centrifuge motor housing of FIG. 11A.

FIGS. 12A-12O illustrate various views of an embodiment of a graphical user interface for entering data into, obtaining data from, and or controlling components of a system such as the portable system of FIG. 8.

FIG. 13 illustrates another embodiment of a portable device for testing and tracking medical specimens and/or medical information.

FIG. 14A illustrates a side view of an embodiment of a centrifuge that can be used with the portable testing and tracking device of FIG. 13.

FIG. 14B illustrates a perspective view of the centrifuge of FIGURE 14A.

FIG. 15A illustrates a side view of a test tube with a magnetic valve that can be used in the centrifuge of FIG. 14.

FIG. 15B illustrates a cross-sectional side view of the test tube and magnetic valve of FIG. 15A.

FIGS. 16A-16D schematically illustrates the fluid separation that can occur in a test tube with a magnetic valve when used with a centrifuge such as that of FIG. 14.

FIG. 17A illustrates a perspective view of a test tube with an embodiment of a tilt valve in the tube.

FIG. 17B is a cross-sectional view of the test tube and tilt valve of FIG. 18.

FIG. 18 schematically illustrates the device of FIGS. 17A-17B tilted at an angle and acting under the forces that can be applied by a centrifuge.

FIG. 19 is an exploded perspective view of the tilt valve of FIGS. 17-19.

FIG. 20A is a perspective view of an example of a medical data storage and/or patient identifying device.

FIG. 20B is a perspective view of another embodiment of a medical data storage and/or patient identifying device.

FIG. 21 is a schematic flow chart showing examples of steps to be performed in gathering medical specimens in an emergency setting, such as storing data relating to specimens, patients, and/or test results, and receiving information from an external source regarding further testing and/or treatment.

### DETAILED DESCRIPTION OF THE PREFERRED EMBODIMENTS

Certain exemplary embodiments of the inventions will now be described. The various features of these embodiments can be combined and/or modified to produce additional embodiments not specifically described, and the subject matter of the inventions can be applied in other contexts, all of which is encompassed by the present inventions.

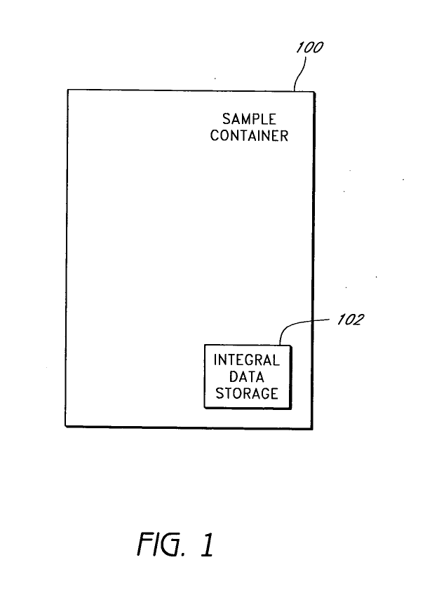

Turning now to FIG. 1, a sample container 100 is provided with an integral data storage device 102. In some embodiments, the sample container 100 is a test tube, such as a test tube for receiving a sample of a patient's blood, and the integral data storage device 102 is an electronic means for receiving electronic signals, storing such signals in a medium, and communicating data relating to such signals to a receiver at the appropriate time. In some embodiments, the integral data storage device 102 is an integrated circuit chip such as a radio-frequency identification (RFID) chip. An example of such a chip is the ME-Y 2004 RFID chip manufactured by Maxell Corporation. Other types of integral data storage devices 102 can also be used. In general, the integral data storage device 102 can provide a way to receive, record, and/or recall various types of data that can be associated with a test sample, preferably in a manner that cannot be read by the unaided eye to preserve confidentiality and will reliably remain with the test sample and not be highly vulnerable to data-reading errors or misidentification errors caused by damage to or misplacement of the identification features on the sample container 100. The integral data storage device 102 can also allow the stored data to be communicated to an external reader when appropriate.

In the illustrated embodiment, the data storage device is integral with the sample container to ensure that these two components cannot be easily separated. The term “integral” as used herein refers to a coupling of two components that is not easily separated; it may include selectively releasable or removable couplings and couplings that are permanently attached. In some embodiments, the permanent attachment ensures that separation of the two components requires destruction of the data and/or one or both of the two components. In some embodiments, a permanent attachment provides the advantage of ensuring that the data storage device cannot be separated from the container under any circumstances. Depending upon the type of sample container 100 in use, a permanent connection between the sample container 100 and the integral data storage device 102 may not be desirable, such as when the sample container 100 is large and/or expensive. Another example where permanent connection may be undesirable is when the two components have different intended lifespans, or if they have disparate uses and their independent existence is desirable.

In contrast with systems and methods for tracking and testing of medical specimens and data currently in use, the integral data storage device 102 is preferably configured to receive a relatively large amount of data relating to the patient and the test performed on the specimen. In contrast, a code identifier, such as in an optical reader, merely links the sample to a computer database where such patient and test information is stored. Of course, the integral data storage device 102 could be configured, if desired, to include only a code for linking the specimen to a database as with an optical reader. This approach would provide numerous advantages over an optically-readable code adhered to the surface of the sample container 100, because it would allow for data to be written to the chip directly, a human would not intervene to potentially misapply a label, there is no risk of illegible human penmanship, and a reduced risk of the code later coming off the container 100. However, further efficiencies and advantages are available if more than just a code is included. By including the data itself in the integral data storage device 102, the specimen is much less vulnerable to misidentification and errors associated with the unreliability of large computer databases. Furthermore, the data is more likely to be consulted if it is more closely associated with the sample itself, and with an appropriate system, data can be used to create a warning or alert that notifies a health care provider of important details regarding a patient's genotype or phenotype. Thus, potential allergic reactions can be avoided and improved diagnosis is possible.

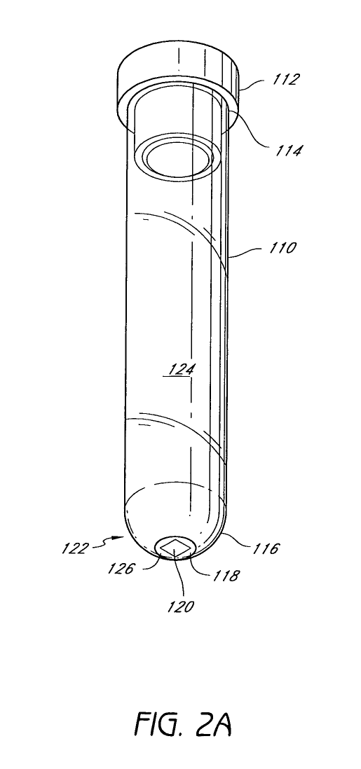

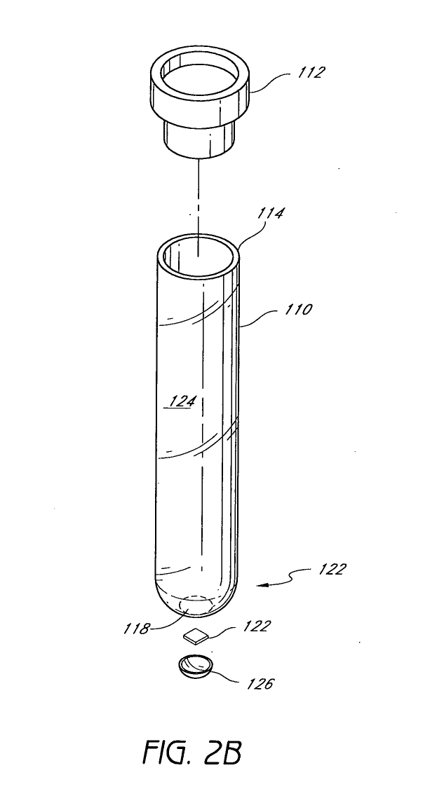

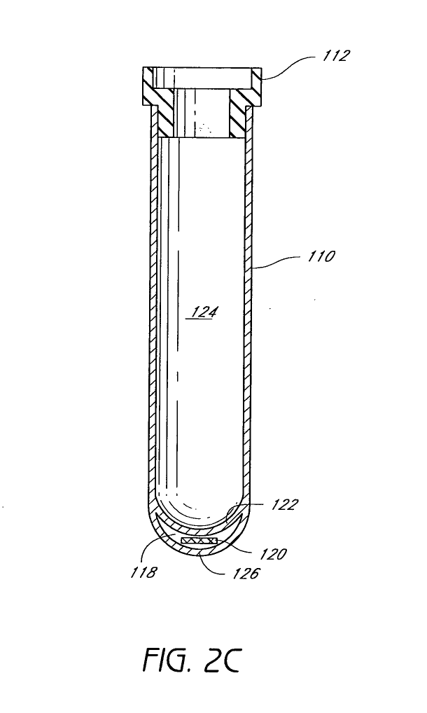

Referring now to FIG. 2A, the sample container 100 of FIG. 1 is illustrated as a test tube 110 with a stopper cap 112 covering the open end 114 of the test tube 110. At the closed end 116 of the test tube 110, there is a chamber portion 118 for containing an integral data storage device 102 as illustrated in FIG. 1. In FIGS. 2A-B, the illustrated integral data storage device 102 is an RFID chip 120.

In the illustrated embodiment, the RFID chip 120 is disposed in the chamber 118 and retained in place in the chamber 118 by a cover 126. The manner of inserting and retaining the RFID chip 120 in the test tube 110 is designed to avoid any damage to the electronic functioning of the RFID chip 120 and to protect the RFID chip 120 and the data stored thereon during processing, transportation, and storage of the test tube 110. The test tube 110 can be subjected to certain environmentally hostile conditions. For example, depending on the type of specimen inserted into the main cavity 124, the test tube 110 may be at times located in a refrigerator, a freezer, or a heater, and subjected to various mechanical forces such as those present in a centrifuge or mechanical conveyance systems. The manner in which the RFID chip 120 is inserted into and retained within the chamber 118 can minimize the risk of data loss associated with such environmental conditions. Moreover, the RFID chip 120 may not be able to tolerate the mechanical and temperature conditions involved in the manufacturing of a test tube 110 without being damaged and losing its functionality. However, if the RFID chip 120 is inserted into the chamber 118 after the test tube 110 is substantially constructed, the manufacturing phase that includes such harsh temperatures and processes has been completed. Thus, the process of inserting the RFID chip 120 can be accomplished with minimal heat or chemical exposure.

In some embodiments, the RFID chip is laminated or encased in a protective coating, which can help insulate the RFID chip from harsh conditions. This can allow the chip to be inserted before a cover 126 (see FIG. 2B) is sealed in place, protecting the RFID chip from harm during the sealing process, for example.

Referring now to FIG. 2B, the test tube 110 is shown with various components shown schematically in an exploded view. The stopper cap 112 is shown in an orientation to be inserted into the open end 114 of the test tube 110. At the closed end 116 of the test tube 110, the chamber portion 118 for containing the integral data storage device 102 (in this case, an RFID chip 120) is illustrated. The RFID chip 120 is shown in an orientation to be placed within the chamber 118, and the cover 126 is shown in an orientation that will enclose the RFID chip 120 and the chamber 118 when they are brought together.

FIG. 2C illustrates the test tube 110 in cross section. The chamber 118 is illustrated in a sealed state, with the RFID chip 120 sealed inside by the cover 126. Furthermore, as illustrated in FIG. 2C, the test tube 110 can include a buffer region 122 between the interior cavity 124 of the test tube 110 and the chamber 118 for containing the RFID chip 120. For convenience, the buffer region 122 can be made of the same material, such as plastic or glass, as the rest of the test tube 110. One purpose of the buffer region 122 is to prevent the contents, such as blood, in the cavity 124 of the test tube 110 from interfering with or being contaminated by the RFID chip 120. In some embodiments, the RFID chip 120 is suspended in a resin or epoxy-like substance (not shown) within the chamber 118. The resin can harden, permanently suspending the RFID chip 120 and simultaneously securing the cover 126 in place.

In some embodiments, each RFID chip 120 mounted in a test tube 110 has its own unique serial number and/or identifying code and can readily be distinguished from other RFID chips, even without relying on any other data stored on the RFID chip. In addition, in some embodiments, the RFID chip 120 can have multiple modes that apply to at least some sets of data. For example, in one mode certain data fields are permitted to be changed by one or more users, for example, healthcare professionals in a physician's office or technicians in a laboratory, and in another mode, such data fields (or other data fields) are “locked” to prevent any change. The mode status, affecting whether data can be changed, can be changed over time and can be applied to some or all of the data, depending upon logistical and security concerns. Certain RFID chips 120 can be programmed with data fields and code with instructions relating to the processing of such data fields.

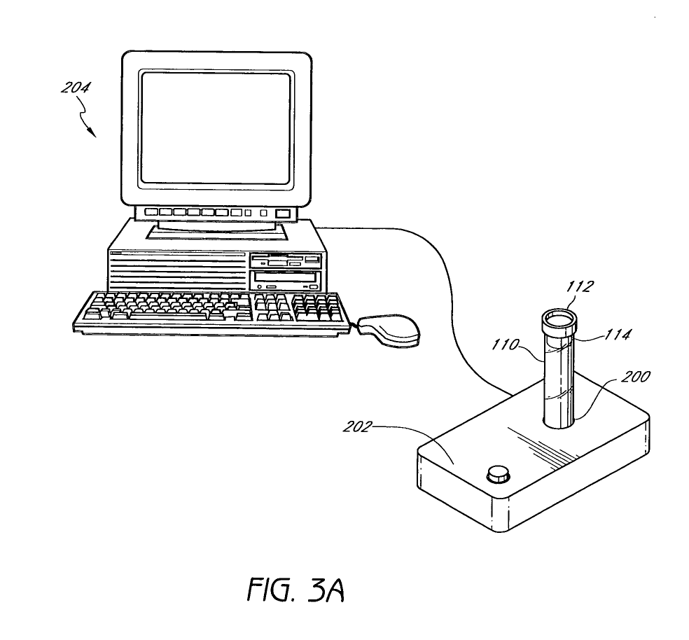

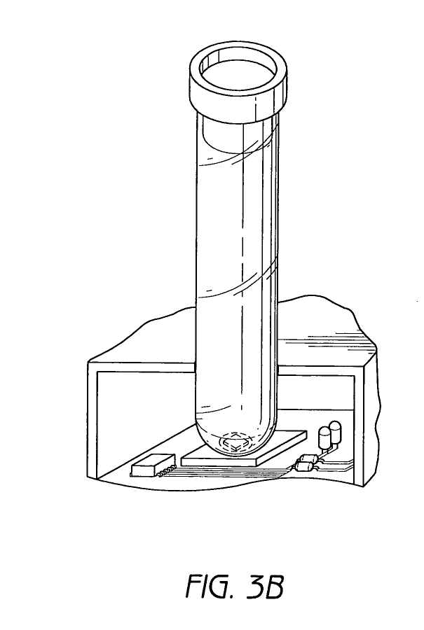

Referring now to FIG. 3A, the test tube 110 can be inserted into a cavity 200 in a read/write device 202. The read/write device 202, in turn, is connected to a data processing device, such as a computer 204. In some embodiments, the read/write device 202 is an NE/Y-2000 chip read/writer manufactured by Maxell, however, many other models and RFID read and/or write devices can be used.

In some embodiments, the read/write device 202 and personal computer 204 are located in a physician's office, or other place where specimens are gathered. After a specimen (such as a body fluid, not shown) is inserted in the test tube 110 and the cap 112 closes the open end 114, the test tube 110 is positioned in the hole 200, and a user begins manipulating software in the personal computer 204 that will communicate with the RFID chip 120 in the test tube 110 to record data on the RFID chip 120 relating to the patient and the type of test to be performed on the contents of the test tube 110.

As shown in FIG. 3B, an apparatus can interface with the RFID chip 120, writing and reading to and from the RFID chip 120.

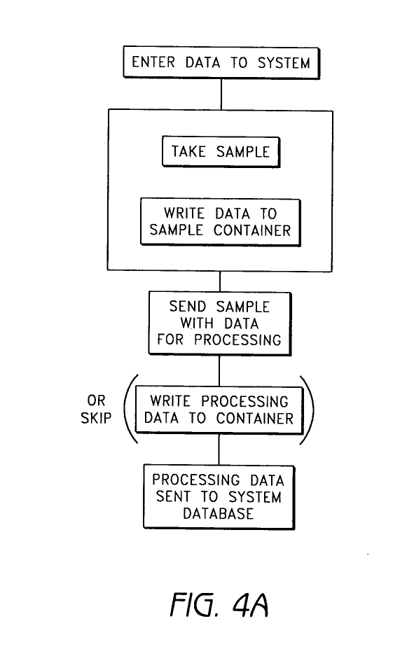

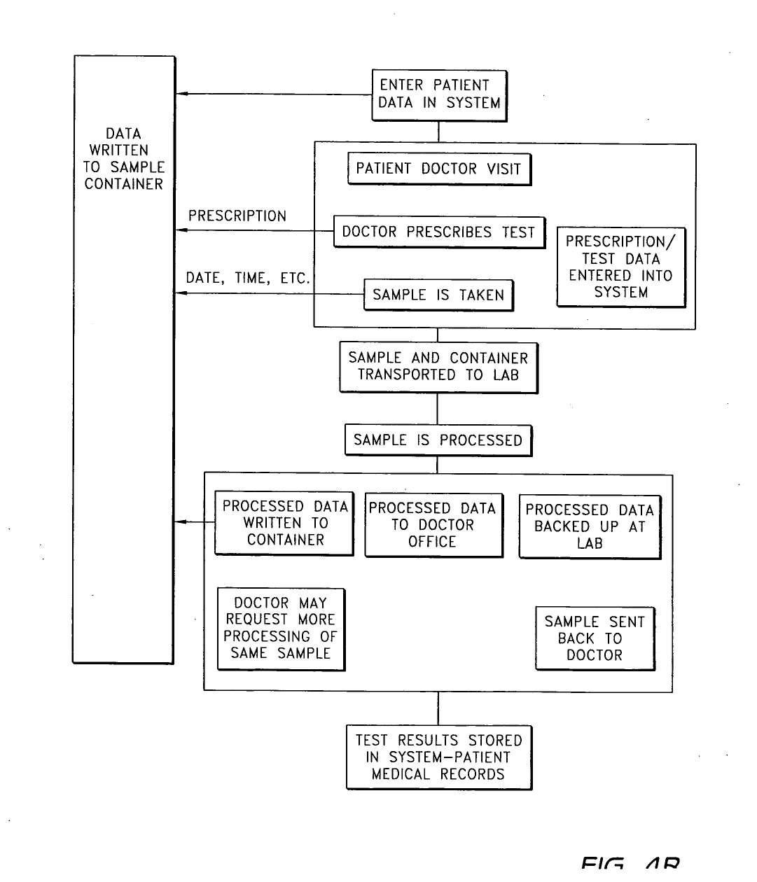

Referring now to FIG. 4A, in certain embodiments, a number of steps are involved in gathering data, recording the data to the integrated data storage device 102, transporting the sample, performing the test, recording the test results, and communicating the test results to the physician and patient. For example, a chip containing medical data that is reliably associated with a medical sample can provide many efficiencies when it is used in connection with a method as illustrated schematically in FIG. 4A. Data can be entered into the system either in response to oral instructions by patient or health care professional, or through other typical data entry means such as using a keyboard or hand-writing recognition. The data can relate to the doctor, the patient (including, for example, the patient's medical history, current symptoms, and insurance information), prescribed test(s), characteristics of the sample when it is taken, the time and location at which the sample is taken, specific requirements for handling or processing of the sample, information relating to which courier and/or laboratory is to handle the sample, predictions or prognoses, etc.

A sample (for example a blood specimen) can then be taken and associated with (e.g., placed in) the sample container 100. At an appropriate time, the data can be “written to” or recorded in or on the integral data storage device 102. As described above, data container can then be “locked” to make the recorded data more permanent or to prevent over-writing or accidental erasure of the data. Furthermore, the data can be encrypted.

After data has been associated with the sample container, the sample can be sent for processing. In advantageous embodiments, the data remains with the sample, even when the sample is exposed to extreme jostling, a decontaminating bath, or other harsh conditions, because the data is embedded within the container itself. The illustrated embodiment allows for a system that requires no forms, lists, or other paper data to be transported in association with the sample. Thus, many potential sources of error and expense are avoided. Whereas in former practice, forms were associated with samples by workers who placed the two in a common container (e.g., a plastic bag), the described system requires no form, no bag, and no extra labor in associating the data with the sample and keeping that data and sample together for an extended period of time.

After the sample has been tested or processed, the data generated by the test(s) can be written to the integral data storage device 102. The data can interact with the data already stored, or it can merely be passively stored. In some embodiments, the data already stored on the integral data storage device 102 can be read by the laboratory system, which can determine test parameters, transmit warnings, specify correct protocol, or identify inconsistensies. Combinations of data can signal the appropriate time to contact the physician, or prompt the laboratory system to establish a separate control, or re-test the sample. Generally, the presence of more data with the sample can provide for more intelligent sample processing, in some cases eliminating the need for further samples, and/or further doctor instructions. For example, doctor-accepted algorithms can be employed to provide further testing of the same sample if a given result is obtained, thus providing the doctor with follow-up information that, under old systems, would have required further samples and further tests.

In some embodiments, the test data need not be written directly to the integral data storage device 102, but can instead be transmitted directly to the doctor and/or the patient, electronically or otherwise. In some embodiments, the test data can be both written to the integral data storage device 102 and transmitted to a doctor and/or patient. The data can also be sent to one or multiple system databases maintained by the health-care provider, the testing facility, the insurance company, and/or the patient.

Referring now to FIG. 4B, a system diagram provides another embodiment of the step-by-step process that can be followed for creating, storing, and tracking medical data. As illustrated, data can optionally be written to the sample container 100 (and integral data storage device 102) at any point during the process. Indeed, the data written to the sample container can include a systematic and accurate record of when each step in the process occurred. Such data can be used for many purposes, such as evidence to prove or disprove malpractice claims, to improve health diagnosis, to improve medical research data, and to track and/or provide evidence relating to criminal activity.

As illustrated, during a patient doctor visit, data can be written to the sample container 100 relating to a prescription, and date and time of sample extraction. Tracking data relating to which courier was responsible and precise departure and arrive times and locations can also be written to the sample containers. Furthermore, such data can be efficiently and/or simultaneously written to the many sample containers being transported—in a batch RFID process, for example.

As illustrated, the data can be backed up at the laboratory and/or sent electronically to a doctor for further diagnosis. The sample can also be sent back to the health care provider (e.g., doctor), or it can also be destroyed once the data is transferred to be stored in a system as part of the patient's medical records.

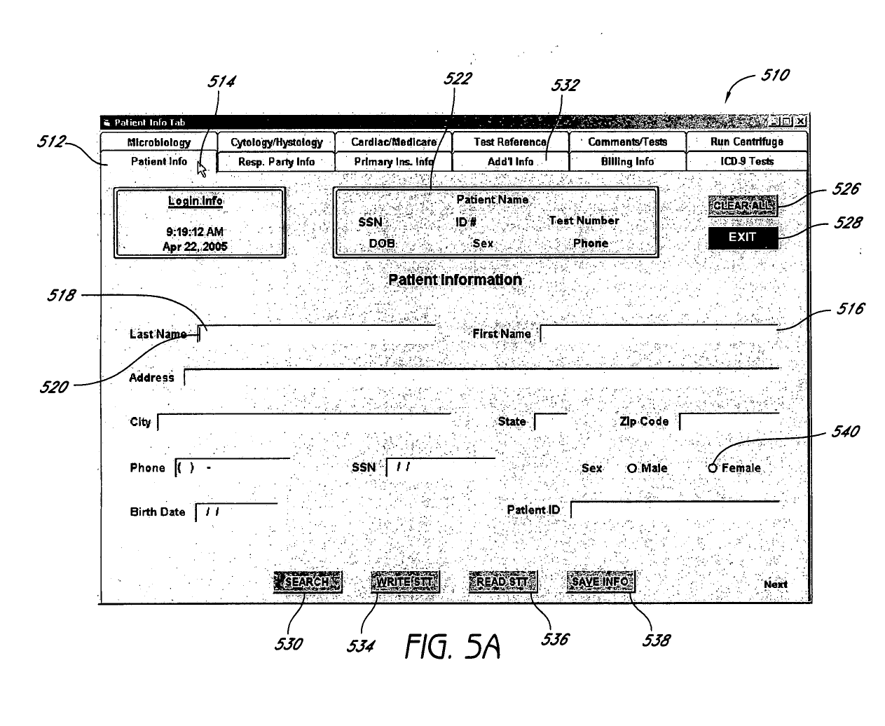

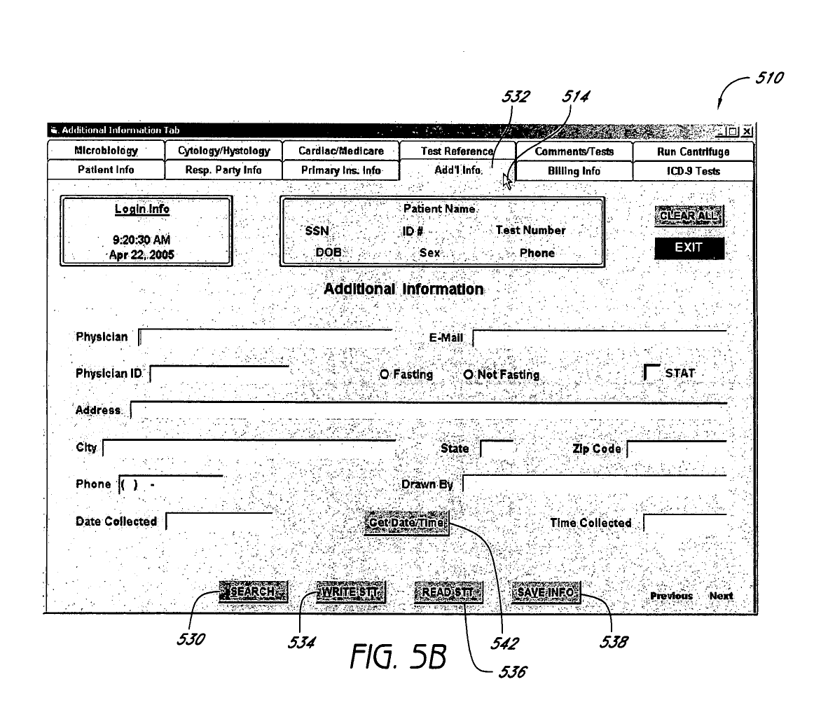

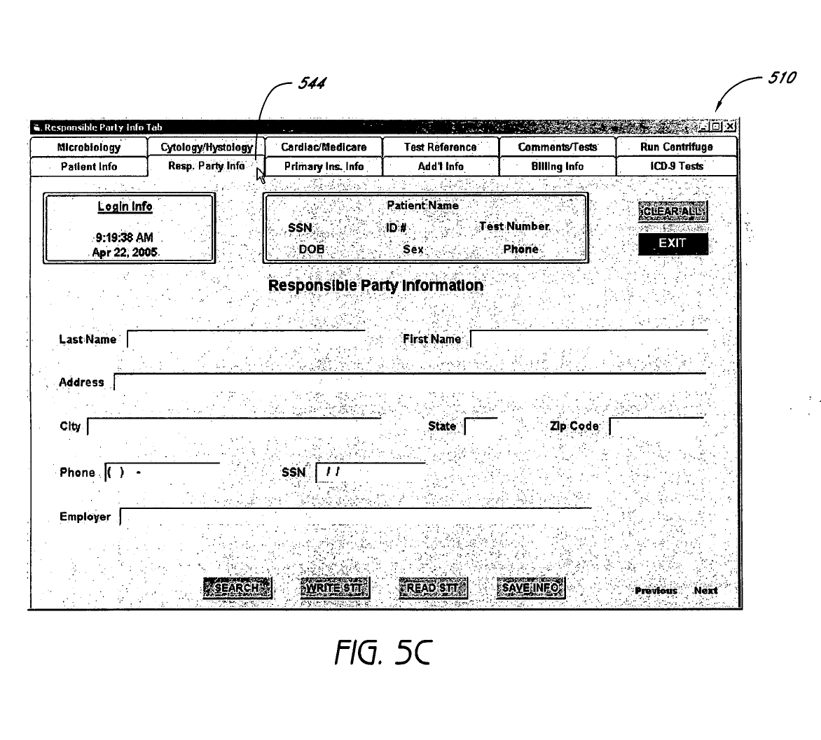

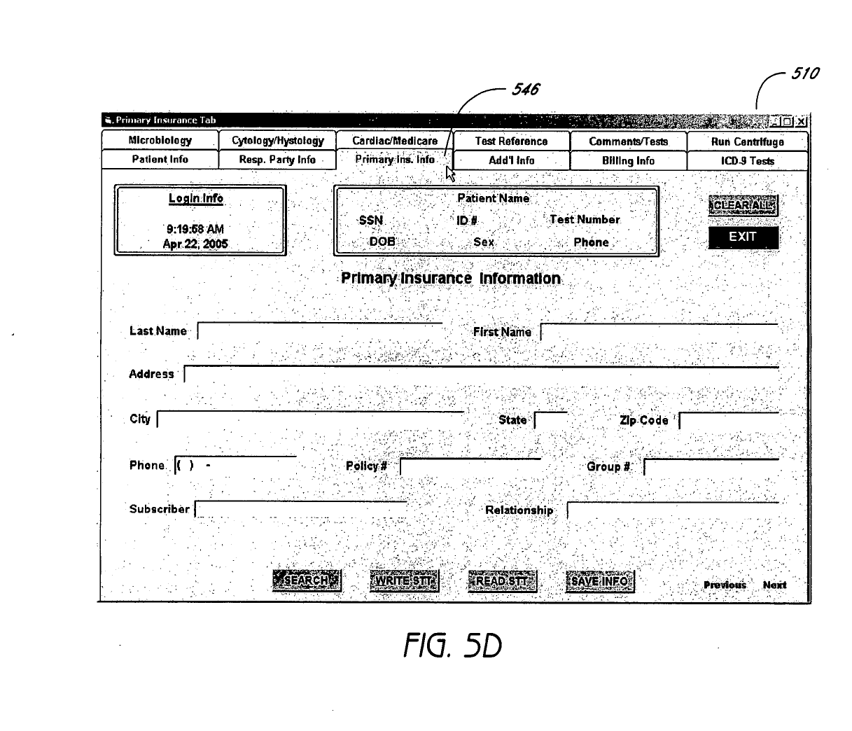

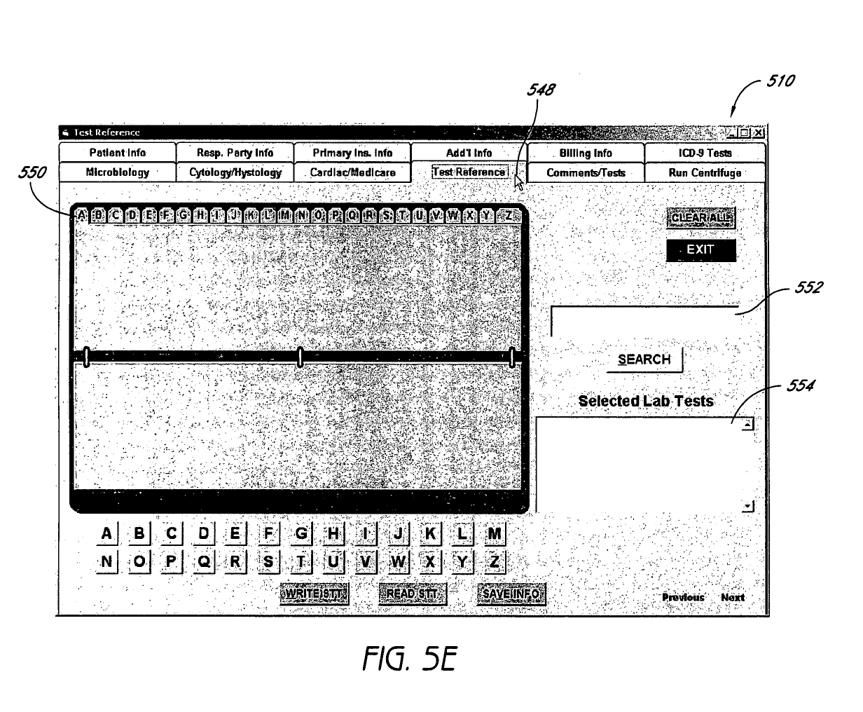

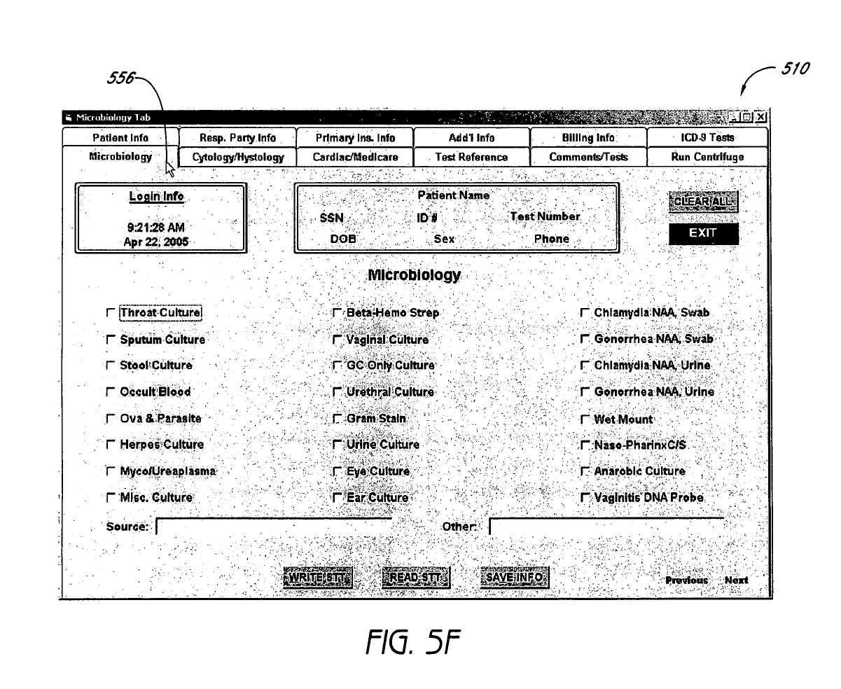

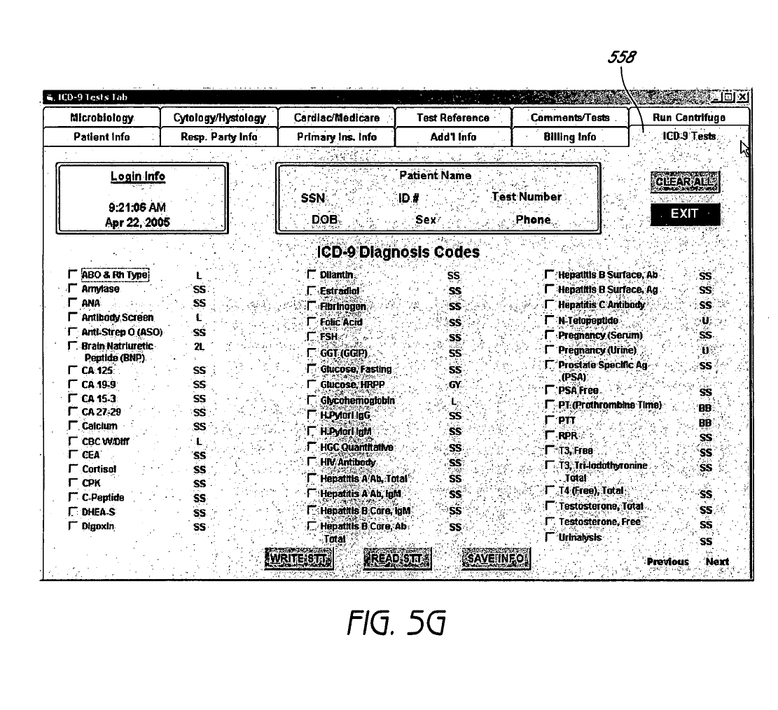

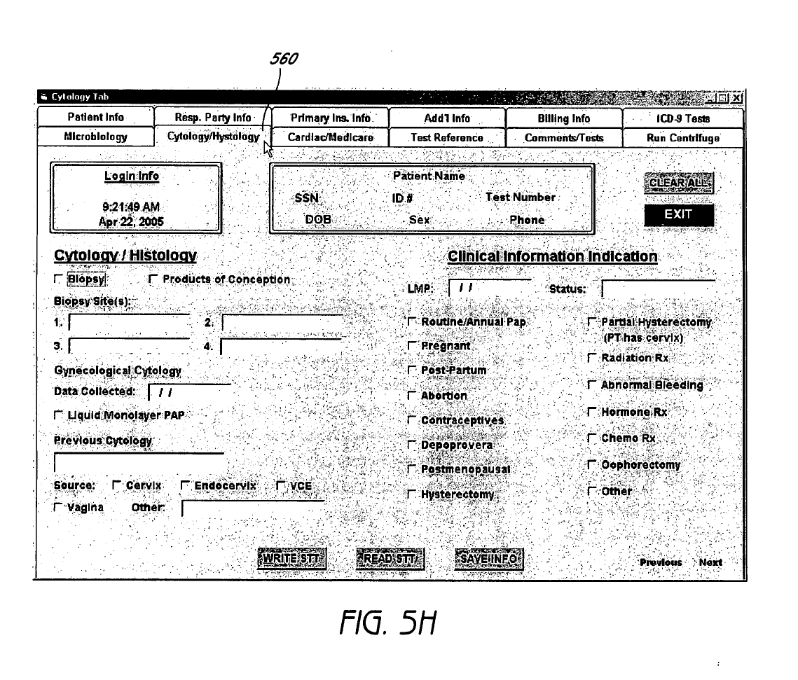

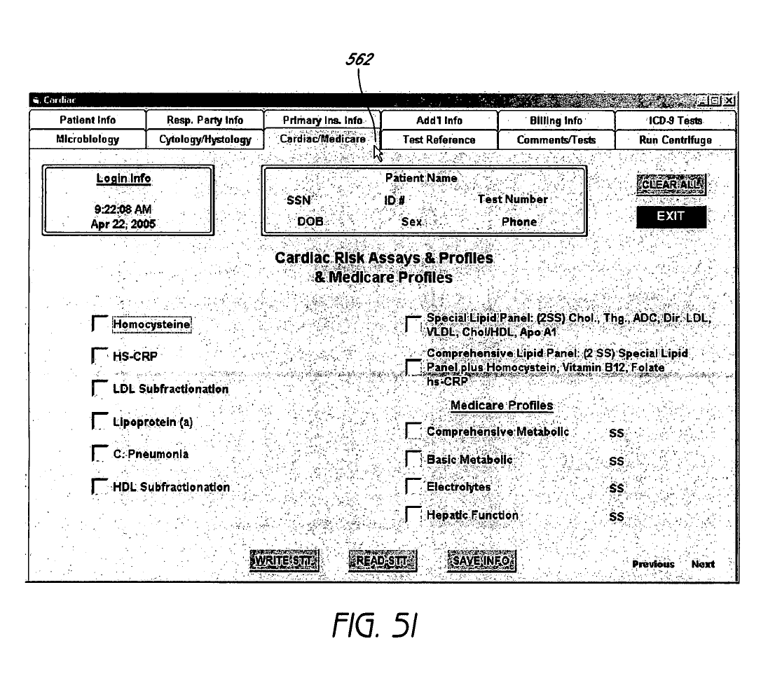

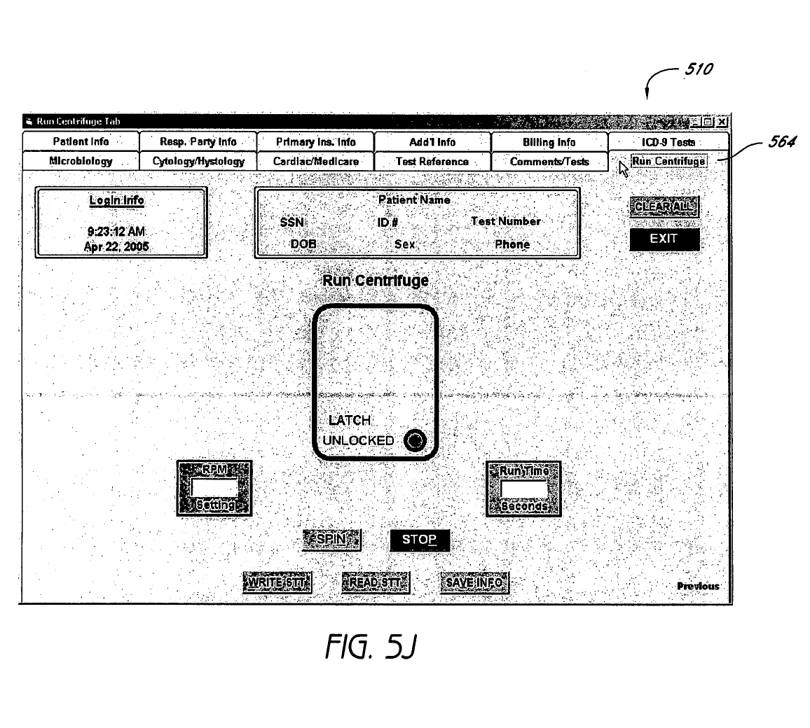

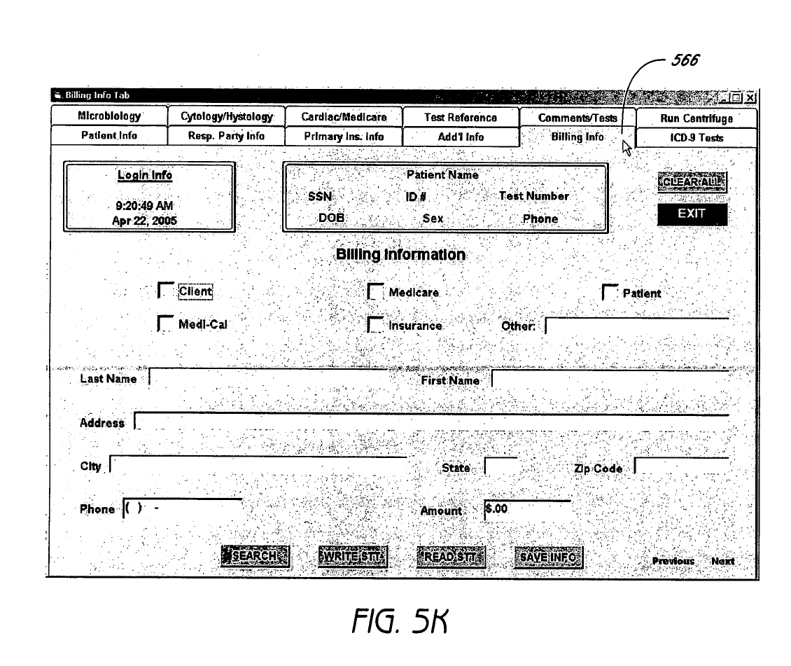

As shown in FIGS. 5A-5L, the data gathering process performed by the user on the personal computer 204, can include gathering and processing various types of data. The data can then be processed and stored in one or more locations, including on the integrated storage device 102.

Referring now to FIG. 5A, a graphical user interface 510 is shown having multiple fields into which the user can enter data. A tab 512 is labeled “Patient Info” and a cursor 514 is shown to indicate that a user has selected the tab 512. One example of a field or data entry is the first name field 516. Another example of a field for data entry is the last name field 518. The patient's last name can be entered into the field 518 by placing a typing cursor 520 in the field, and then typing the letters of the patient's last name into the computer keyboard that may be associated with the computer 204 shown in FIG. 3A. Manipulation of the typing cursor 520 and the cursor 514, as well as entry of alphanumerical data, can be accomplished through use of a computer mouse, computer keyboard, voice recognition technology, touch screen technology, etc.

An information box 522 is illustrated near the top of the graphical user interface 510. Various words indicate placeholders for identification information. In some embodiments, the information box 522 is populated with information simultaneously with data entry into the fields of the patient info tab 512. For example, as a patient's last name is entered into the field 518, the word “Patient Name” in the information box 522 is replaced with the patient's last name, and likewise as the first name of the patient is entered. Other, inactive tabs are shown at the top of the graphical user interface 510. For example, the additional info tab 532 is shown in a different, lighter color than the patient info tab 512. This can indicate that the patient info tab 512 is currently active, and that the graphical user interface 510 is currently displaying fields related to patient information instead of additional information. A log-in information box 524 is shown at the upper left side of the graphical user interface 510.

As illustrated, the log-in information box 524 can display the current time that the computer program is being used, or it can display the time at which the user logged in to the system. The date can also be displayed. At the top right corner of the graphical user interface 510, is a clear-all button 526. The clear-all button 526 can be used, in some embodiments, to delete the data entered in the various fields of the patient information tab 512 with a single click. An exit button 528 is also located at the top right corner of the graphical user interface 510. Clicking on the exit button 528 with the cursor 514 can end the program. A search button 530 is found at the bottom left-hand side of the graphical user interface. The search button 530 can be used to initiate an electronic data search. A write STT button 534 can be used to record or write data to an RFID chip 120. A read STT button 536 can be used to read data from an RFID chip 120.

A save information button 538 can be used to record the data entered through the graphical user interface 510 to a computer 204. The word “Next” appears at the bottom right-hand corner of the graphical user interface 510, and if the cursor 514 is used to click on the word “Next,” a user can be directed to another portion of the graphical user interface 510 to enter more data or perform some other task. A selection field 540 can be used for the entry of some data, instead of an alphanumeric data entry field such as the first name field 516. For example, to indicate the gender of the patient, the user can select either the male or female option. If the female option is selected, the user places the cursor 514 over the selection field 540 and clicks on that portion of the graphical user interface 510. In some embodiments, a black dot will appear in the field 540 to indicate that female has been selected. Preferably, the program functions to only permit one of the male or female selection fields to be indicated at a time. As illustrated, various information can be entered into the fields of the patient information tab 512. For example, the patient's last name, first name, address, city, state, and zip code can be entered. Furthermore, the patient's phone number, social security number (indicated by SSN), sex, birth date, and patient identification can be entered.

Referring now to FIG. 5B, the cursor 514 has now been moved to select the additional information tab 532 of the graphical user interface 510. The data entry fields on this tab and other features are similar to those described with respect to FIGURE 5A. The additional information that can be entered when the additional information tab 532 is active, as illustrated, can comprise the following: physician, e-mail address, physician identification, whether or not the patient is fasting at the time of the test, stat, address of the physician, city, state and zip code of the physician, phone number of the physician, name of the person by which the specimen was drawn, the date the specimen was collected, and the time the specimen was collected. The get date/time button 542 can be used to record the date and time that is present in the computer 204, without the user being required to independently evaluate the date and time. The word “Previous” appears at the bottom right-hand corner of the additional information tab of the graph tab 532 of the graphical user interface 510. By clicking on the word “Previous,” the previous tab in a predetermined sequence can be accessed, in a similar fashion to the earlier described us of the word “Next.” The search button 530, the write STT button 534, the read STT button 536, and the save information button 538 are all present on the additional information tab of the graphical user interface 510 no matter which tab is active. The buttons can be accessed at any point during the data entry, and data can be saved, read, or written at any time.

Referring now to FIG. 5C, the responsible party information tab 544 has been selected. When the responsible party information tab 544 is active, the following data can be entered using the graphical user interface 510: the responsible party's last name, first name, address, city, state, zip code, phone number, social security number, and employer.

Referring now to FIG. 5D, the primary insurance information tab 546 is now active. As illustrated, the following information can be entered into the system through the graphical user interface 510 when the primary insurance information tab 546 is active: the last and first names of the person who is the primary insured, as well as the address, city, state, and zip code of that person. The primary insured's phone number, policy number, group number, subscriber information, and relationship to the patient can also be entered.

Referring now to FIG. 5E, the test reference tab 548 is now active. In some embodiments, the test reference tab can provide information regarding the available tests that can be performed on biological or medical samples. For example, the alphabetical index cards 550, a portion of the graphical user interface 510 that has been designed to have the general schematic appearance of tabbed index cards on a three-ring fastener, can contain information relating to various tests that can be performed. Clicking on the various letters located at the top of the virtual index cards can bring the tests that begin with that letter into view. Alternatively, the alphabetical buttons at the bottom left-hand side of the test reference tab can be used to select which tests are shown. A search field 552 is also available, into which search terms can be typed to locate a test if portions of the test information are known, but not the name, for example. Multiple lab tests can be selected and a selected lab test field 554 is provided for indication of which lab tests have been selected by the user.

Providing the doctor with a way to access a database of possible tests and procedures can greatly improve health care efficiency. For example, in the past if codes and reference numbers were located in a notebook or multi-page volume, much time could be lost in searching for this information and filling out form correctly. Data entry fields that automatically search and automatically complete recognized words from the database can also assist in this process. Combining the step of filling out forms with the step of looking up data for the forms is especially effective when both steps are part of a computerized data system, as described here.

Referring now to FIG. 5F, the microbiology tab is now active. Several potential tests are listed on the microbiology tab, each with a checkbox field associated with it. A user can select any of these boxes to indicate which test is needed or which test has been performed. The various microbiology tests can include the following: Throat Culture, Sputum Culture, Stool Culture, Occult Blood, Ova and Parasite, Herpes Culture, Myco/Ureaplasma, Misc. Culture, Beta-Hemo Strep, Vaginal Culture, GC Only Culture, Urethral Culture, Gram Stain, Urine Culture, Eye Culture, Ear Culture, Chiamydia NAA Swab, Gonorrhea NAA Swab, Chiamydia NAA Urine, Gonorrhea NAA Urine, Wet Mount, Naso-Pharinx C/S, Anarobic Culture, And Vaginitis DNA Probe. The source information and other information can also be entered.

Referring now to FIG. 5G, the ICD-9 tests tab 558 is active. The ICD-9 tab provides boxes that can be checked that correspond to various tests and/or diagnosis procedures. Each diagnosis corresponds to a short code that is indicated next to the diagnosis. As illustrated, the following ICD-9 diagnosis code are available: ABO & Rh type (L); Amylase (SS); ANA (SS); Antibody Screen (L); Anti-Strep 0 (ASO) (SS); Brain Natriuretic Peptide (BNP) (2L); CA 125 (SS); CA 19-9 (SS); CA 15-3 (SS); CA 27-293 (SS); Calcium (SS); CBS W/Diff (L), CEA (SS); Cortisol (SS); CPK (SS); C-Peptide (SS); DHEA-S (SS); Digoxin (SS); Dilantin (SS); Estradiol (SS); Fibrinogen (SS); Folic Acid (SS); FSH (SS); GGT (GGIP) (SS); Glucose, Fasting (SS); Glucose, HRPP (GY); Glycohemoglobin (L); H. Pylori IgG (SS); H. Pylori IgM (SS); HGC Quantitative (SS); HIV Antibody (SS); Hepatitis A Ab, Total (SS); Hepatitis A Ab, IgM (SS); Hepatits B Core, light (SS); Hepatitis B Core, Ab Total (SS); Hepatitis B Surface, Ab (SS); Hepatitis B Surface, Ag (SS); Hepatitis C Antibody (SS); N-Telopeptide (U); Pregnancy (Serum) (SS); Pregnancy (Urine) (U); Prostate Specific Ag (PSA) (SS); PSA Free (SS); PT (Prothrombine Time (BB); PTT (BB); RPR (SS); T3, Free (SS); T3, Tri-lodothyronine Total (SS); T4 (Free), Total (SS); Testosterone, Total (SS); Testosterone, Free (SS); and Urinalysis (SS).

Referring now to FIG. 5H, the cytology/histology 560 is active. This tab provides cytology/histology information at the left and clinical information indication fields at the right. As illustrated, a biopsy and/or products of conception box can be checked. Biopsy sites can also be indicated in the four fields shown. Gynecological cytology data collection date can be entered, a liquid monolayer PAP box can be checked, and data relating to previous cytology can be entered. Additionally, a source can be indicated such as a cervix, endocervix, VCE, vagina or other period. Regarding the clinical information indication portion of the cytology/histology tab 560, LMP data and status data can be entered. In addition, the following boxes can be checked: Routine/Annual Pap, Pregnant, Post-Partum, Abortion, Contraceptives, Depoprovera, Postmenopausal; Hysterectomy; Partial Hysterectomy (PT has cervix); Radiation Rx; Abnormal Bleeding; Hormone Rx; Chemo Rx; Oophorectomy; or Other.

Referring now to FIG. 51, the cardiac/Medicare tab 562 is now active. Information relating to cardiac risk assays and profiles and Medicare profiles can be entered at this tab. For example, the following cardia risk assays can be selected: Homocysteine; HS-CRP; LDL Subfractionation; Lipoprotein (a); C. Pneumonia; HDL Subfractionation; Special Lip Panel; and Comprehensive Lip Panel. The following Medicare profiles can also be selected: Comprehensive Metabolic (SS); Basic Metabolic (SS); Electrolytes (SS); and Hepatic Function (SS).

Referring now to FIG. 5J, the run centrifuge tab 564 has been selected and is active. This portion of the graphical user interface 510 can be used to control a component of the system that is external to the computer 204. A centrifuge can be used to process a sample such as a whole blood sample. As illustrated, the controls of the centrifuge can be located on the run centrifuge tab, and can include an RPM setting, a run time setting, a spin button, a stop button, and an indicator of whether the centrifuge is latched or unlocked.

Referring now to FIG. 5K, the billing information tab 566 has been selected. Billing information that can be entered at this tab includes: whether or not the client Medicare patient, Medical insurance or other is to be billed; the last name, first name, address, city, state, zip code, and phone number of the entity to be billed; and an amount to be billed.

Referring now to FIG. 5L, the comments/tests tab 568 is now active. This tab provides data entry fields for comments from the user on the left, and a list of fields at the right for additional tests to be performed. If a physician, nurse, or other healthcare provider wishes to indicate a unique or unlisted test, the test may be described in one of these fields without the healthcare professional having to select from a predetermined database.

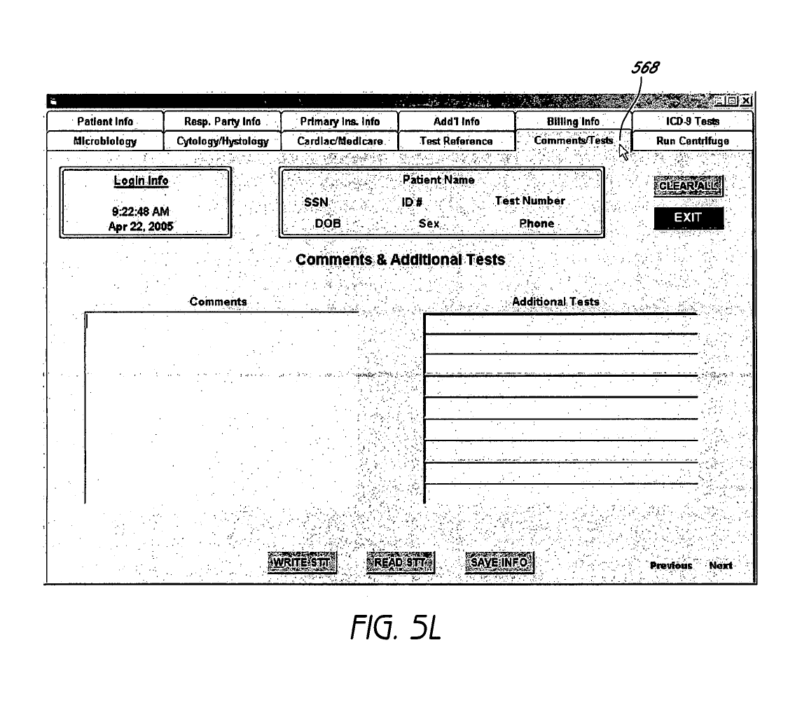

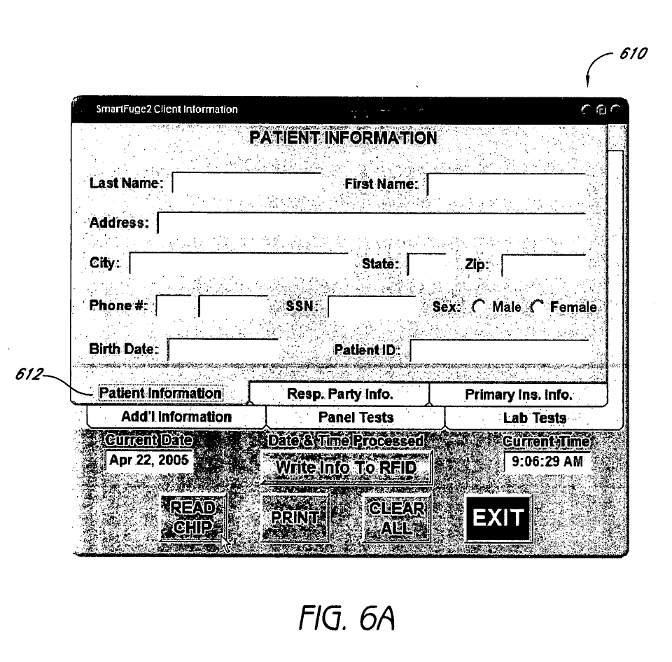

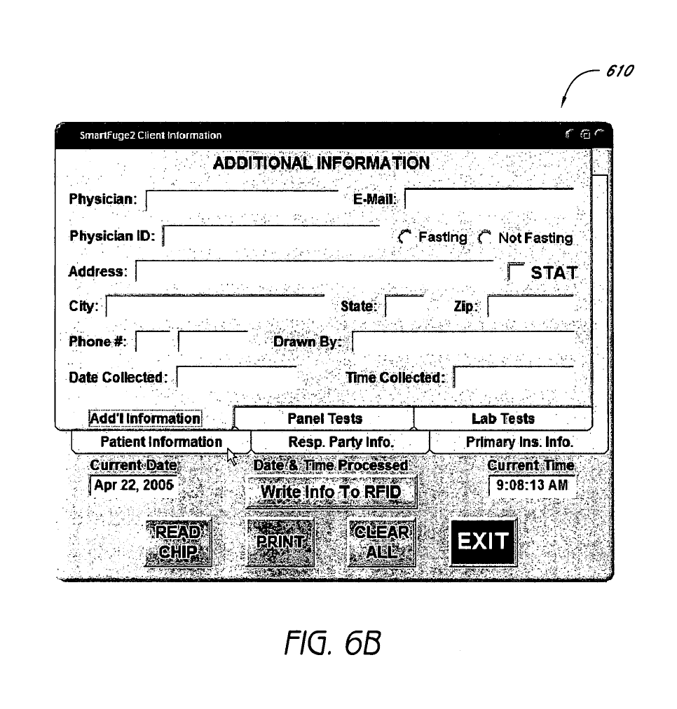

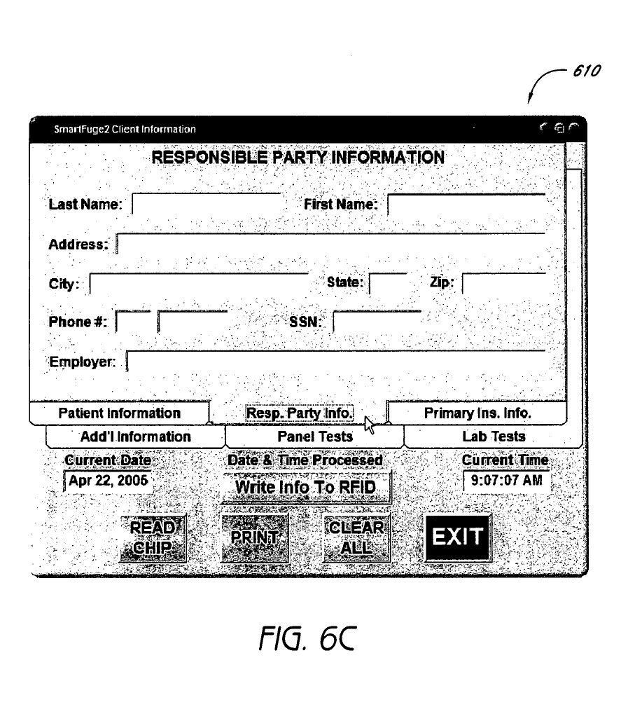

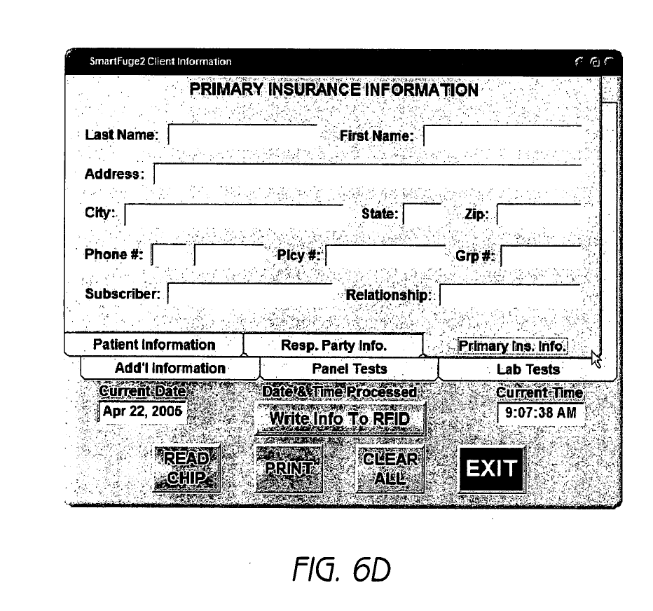

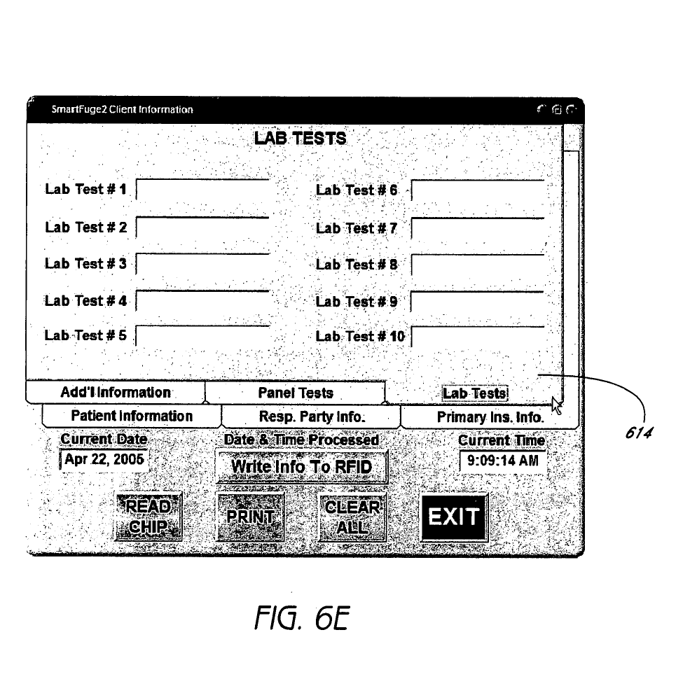

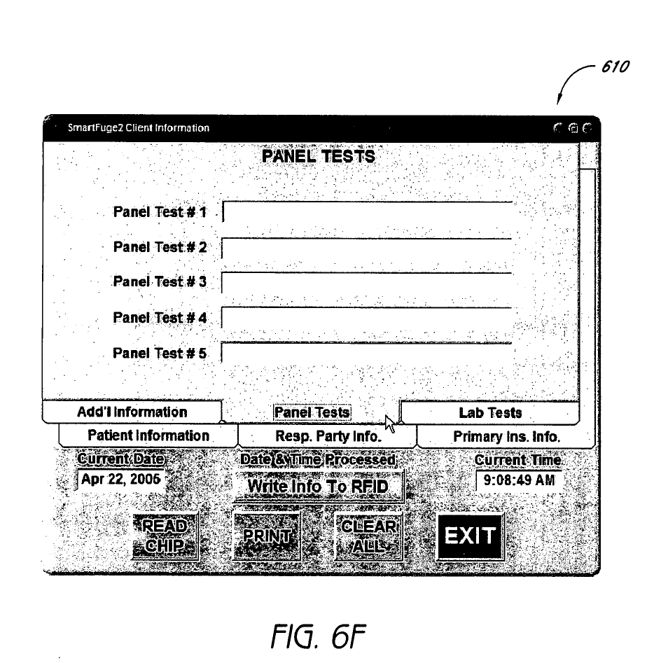

The illustrated and described embodiments of the graphical user interfaces in FIGS. 5A-5L provide insight into the underlying software that can be used to process the data and control device function as indicated by the fields, buttons, controls, etc. of the graphical user interfaces. The illustrated and described embodiments are illustrative examples of the many interfaces, programs, data, functions, and formats that can be used. Many other interfaces, programs, data, functions, and formats can also be used. The embodiments illustrated in FIGS. 6A-6F can also take many other forms and the inventions are not limited to these illustrated examples.

Referring now to FIGS. 6A-6F, the data-gathering process can be performed by a user through an electronic system associated with a sample processing device. FIG. 6A illustrates a graphical user interface 610 for entering or reading data that can be associated with a laboratory device. For example, the graphical user interface 610 can be used by a technician at a blood processing center to access data that is stored on an RFID chip 120. The data entered through a graphical user interface 510 as illustrated in FIGS. 5A-5L can also be displayed by the graphical user interface 610. The data on an RFID chip 120 can thus be read and accessed by various programs using various graphical user interfaces. The graphical user interface 610 provides fields for the entry of patient information, in a similar way to the graphical user interface 510. Also similar is the system of tabs that can be activated, including a patient information tab 612, which is activated in FIG. 6A. The patient information tab comprises fields for the entry of patient information, including the patient's last name, first, address, city, state, zip code, phone number, social security number, sex, birthday, and patient identification number.

Referring now to FIG. 6B, additional information can be entered into the graphical user interface 610, including the physician's name and e-mail address; the physician identification; whether the patient was fasting or not fasting; the address, city, state, zip code, and phone number of the physician; and the person who drew the specimen, the date it was collected, and the time it was collected. In some embodiments, the information provided in the graphical user interface 610 can be locked so that the information cannot be changed when it is read by a healthcare worker at a testing laboratory. This can provide data security so that the data is not changed after it is initially entered. In this case, the fields are not data entry fields but instead merely display the data that has been previously entered using a system such as that illustrated in FIG. 5, for example.

Referring now to FIG. 6C, the responsible party information can also be displayed by the graphical user interface 610. The responsible party's last name, first name, address, city zip code, phone number, social security number, and employer can be displayed and/or entered.

Referring now to FIG. 6D, the information relating to the primary insurance holder can be displayed and/or entered. For example, the primary insured's last name, first name, address, city, state, zip code, phone number, policy number, group number, subscriber information, and relationship information can be entered.

Referring now to FIG. 6E, the lab tests that have previously been selected using the graphical user interface 510 can be displayed at the lab tests tab 614. The various fields for data display and/or entry in FIG. 6E can correspond to the lab test checkboxes listed in FIG. 5.

Referring now to FIG. 6F, panel tests can also be displayed in a similar fashion to the lab tests of FIG. 6E. The graphical user interface 610 can be used to convey information to a lab technician by way of the illustrated graphical user interface 610.

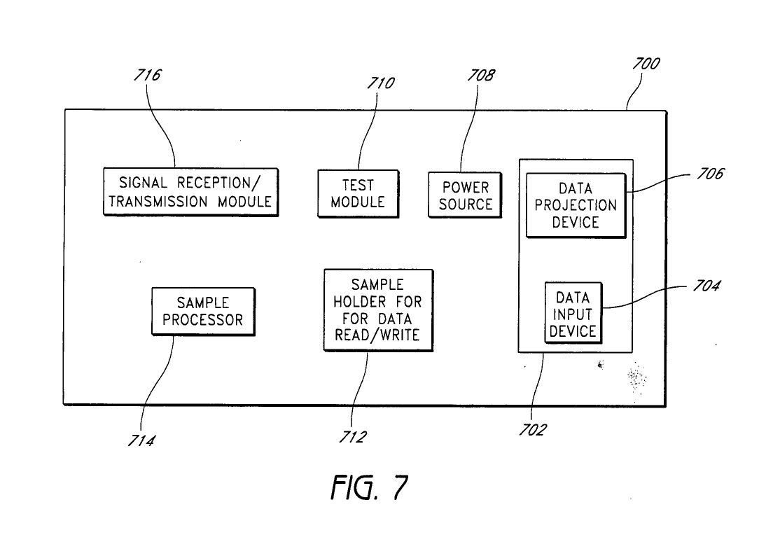

Referring now to FIG. 7, a system and method for tracking of data and/or testing of medical specimens, with a portable component, is illustrated schematically. A portable component 700 can be especially useful in the field, where more complex hospital or emergency care facilities are unavailable. Such a portable system can be useful for first responders in an emergency, for health workers in a medical crisis, for epidemiologists, and for medics on the field of battle. Such a system can be used to test for biotoxins, blood chemistry, blood alcohol content, presence of steroids, toxic chemical agents, etc.

The portable component 700 can include various devices and subsystems. For example, a user interface 702 can include a data input device 704 that provides a means for receiving data input from a user and a data projection device 706 that allows for communicating information to a user (e.g., a screen, a speaker, an LED display, etc.). The data input device 704 can be a keyboard, a touch screen, voice recognition, a mouse, a touchpad, or other systems and devices for data input. The data projection device 706 can be a computer screen and/or a speaker, or another structure for displaying or communicating information processed by a computer. The power source 708 can be a battery, such as a rechargeable battery, or a plug for connecting the portable component 700 to a separate power source. Other sources of power can also be used.

The test module 710 is preferably removable from the remainder of the portable component 700, and can allow for automatic testing of a specimen. For example, different test modules can correspond to different tests that can be performed to analyze or modify biological samples. The test module can have a receptacle for the sample, or for a container enclosing the sample. The test module can have devices for removing and/or testing portions of the biological sample, including tubes, needles, passageways, compartments, robotic portions, closeable orifices, etc. In some embodiments, the test module can handle the sample testing automatically so an emergency responder can avoid contaminating (or being contaminated by) the biological sample. Such a system can be especially useful for HAZMAT teams, for example, who may be encumbered with protective gear, and thus less able to perform tests on delicate biological specimens.

As shown in FIG. 7, in some embodiments, the test module can be a container with various materials used to obtain a specimen from a patient. Such materials can include test tubes, such as the test tube illustrated in FIG. 2, reagents, syringes, cotton swabs, sterile strips, antibiotic ointment, catheters, blood preservatives, and other equipment routinely used for collecting specimens. The sample holder 712 temporarily secures a sample container 100, such as the test tube 110, while data is written on to or read from the integral data storage device 102, such as the RFID chip 120. The sample processor 714 is a component that can process a physical specimen. The sample processor 714 can interact with the test module 710 to test and/or process a specimen. Examples of such processing can involve the application of mechanical forces, such as in a centrifuge, or other treatments such as chemical, electrical, optical, electromagnetic, temperature-based, and/or radioactive processing. Some particularly useful embodiments include a sample processor 714 that comprises a centrifuge for separation of fluid (e.g., blood) constituents.

The signal reception/transmission module 716 can allow information, such as data about the patient or test results, to be communicated to or from another location, such as a doctor's office, a law enforcement database, a regulatory database relating to control of diseases (such as a CDC database), a disaster control unit, or other location for storing or processing data. The signal reception/transmission module 716 can employ radio, Bluetooth, cellular, satellite, or other wireless technology. The signal transmission module 716 can also provide an uplink or a downlink to another communications system such as a telephone, a local area network, a radio repeater, a mobile vehicle communication center, a CB radio, a satellite link, and/or an AWACS or other military communications center.

The portable module 700 can be particularly effective when used in conjunction with a sample container 100 having an integral data storage device 102, because it can be particularly awkward to deal with adhesive sample labels or hand-written medical data while performing analysis in the field. In some embodiments, the data input device 704 can allow an emergency responder to vocally describe a victim, for example, and record the vocal description on the specimen sample by using a read/write device associated with the sample holder 712. Another advantage of combining the portable module 700 with a sample container 100 is the efficiency of recording test results, transmitting data relating to the sample and/or test results, and recording received data relating to the sample or the sample source. For example, test results may be analyzed remotely and a doctor at a remote location can transmit electronic instructions to the portable module and/or module operator about further testing or about treatment approaches. Such a portable testing system can also help in the triage of disaster victims to determine where to concentrate medical resources.

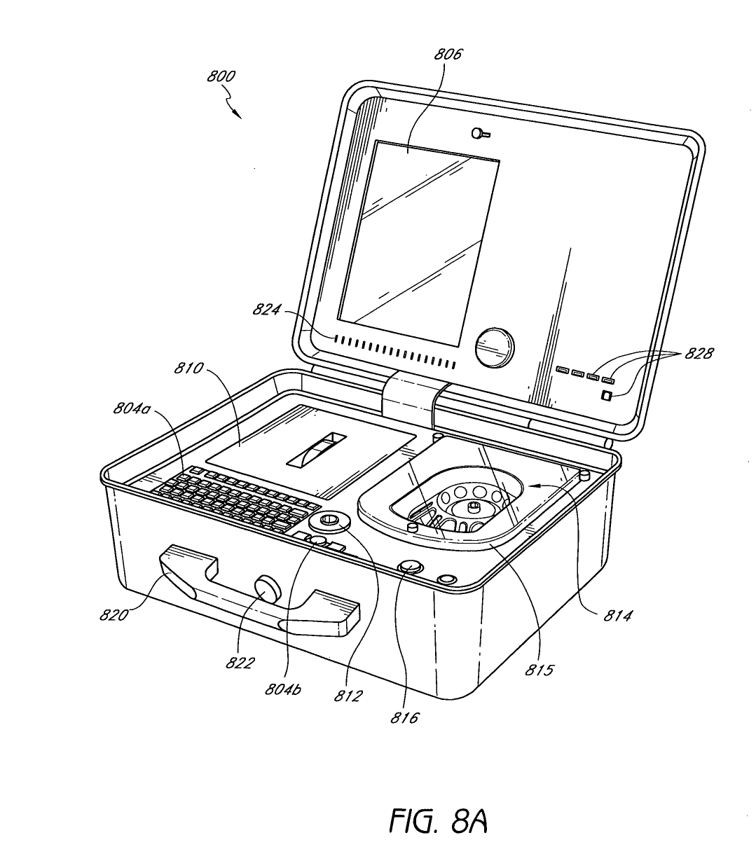

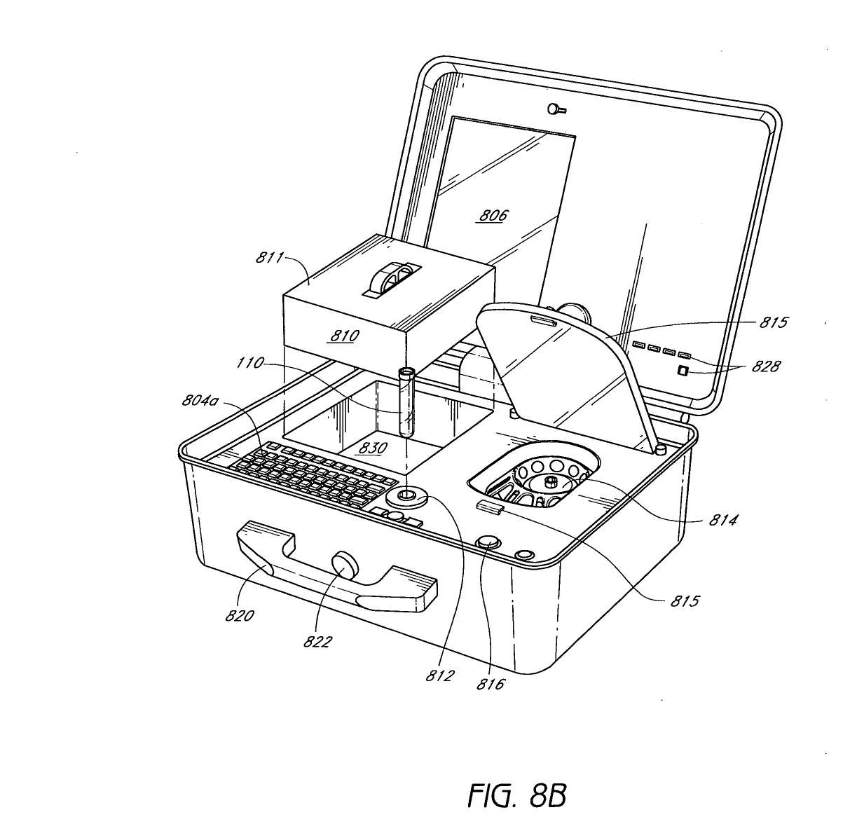

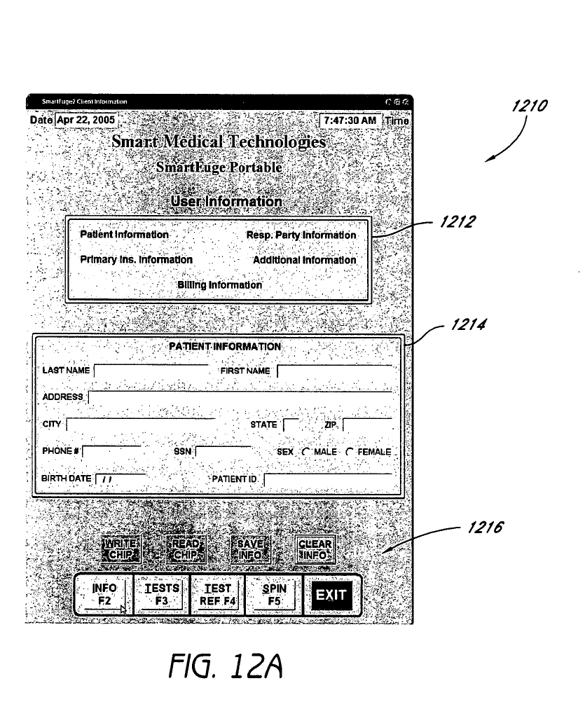

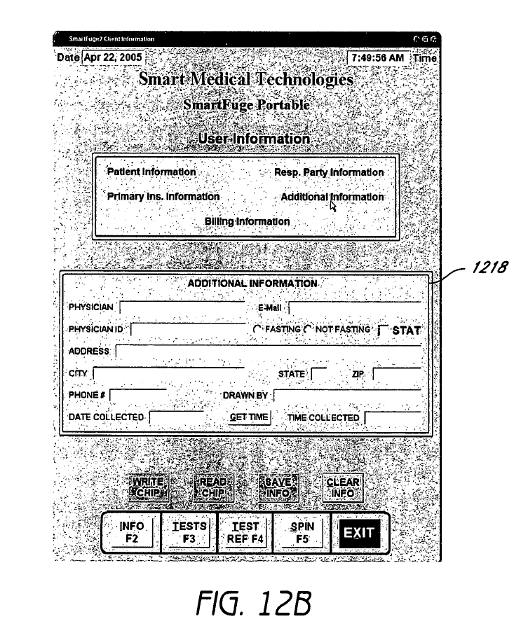

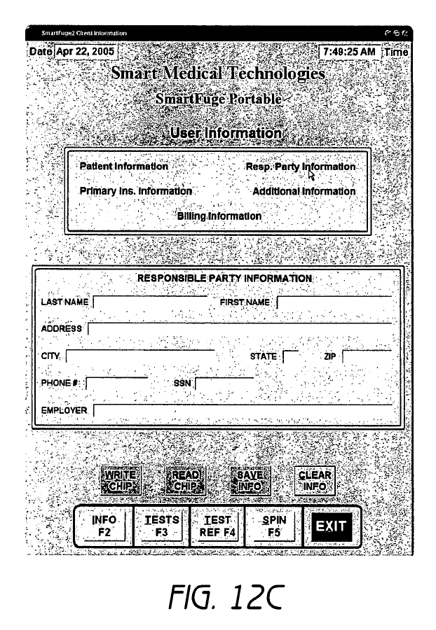

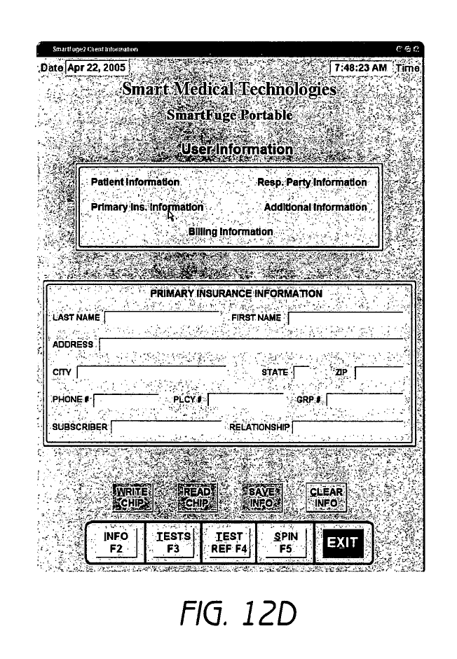

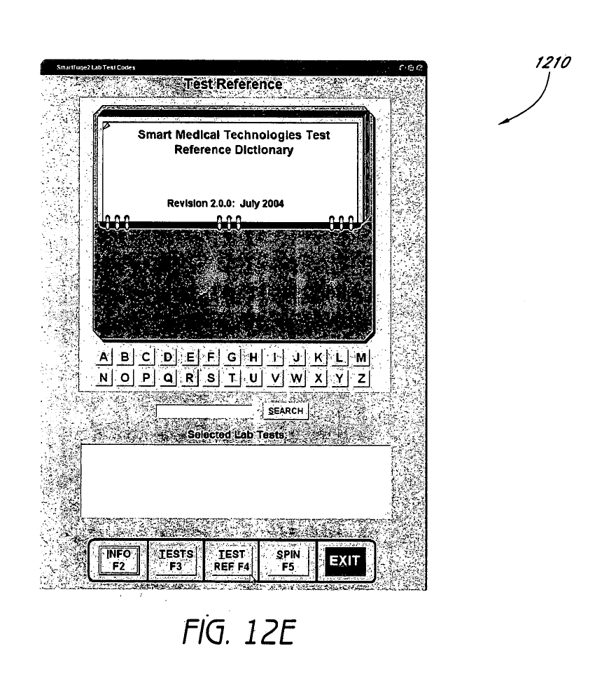

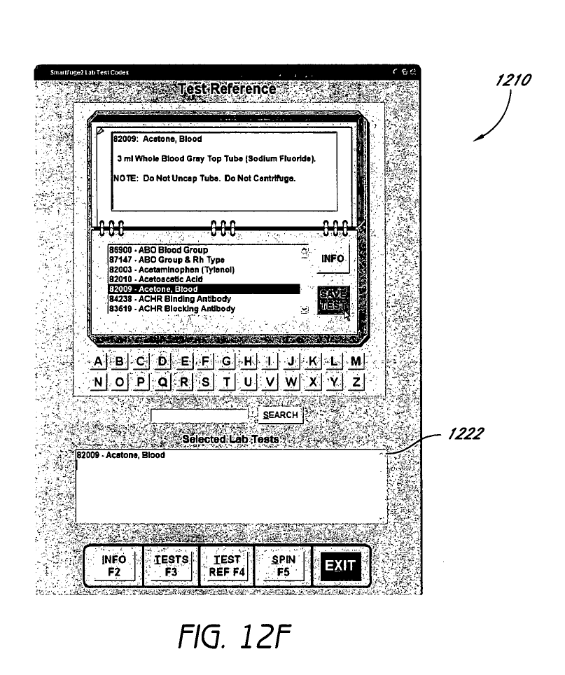

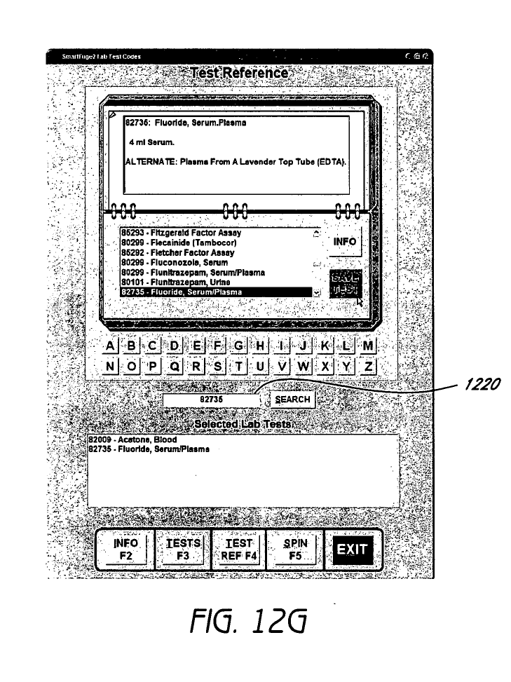

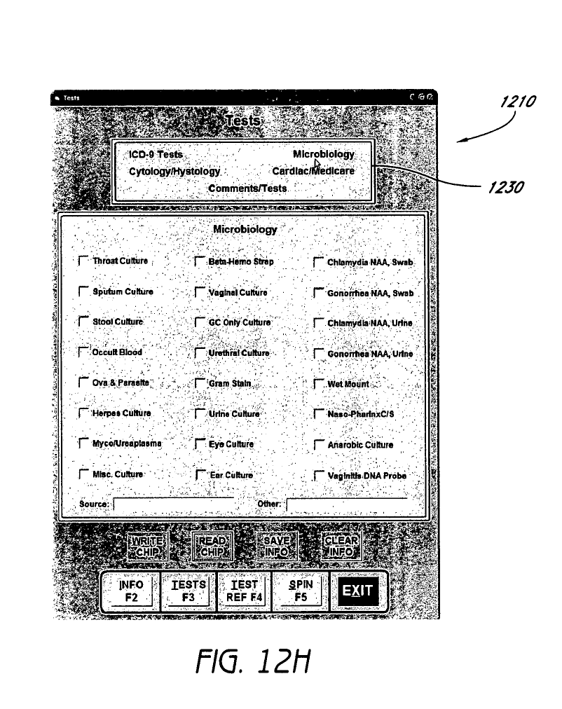

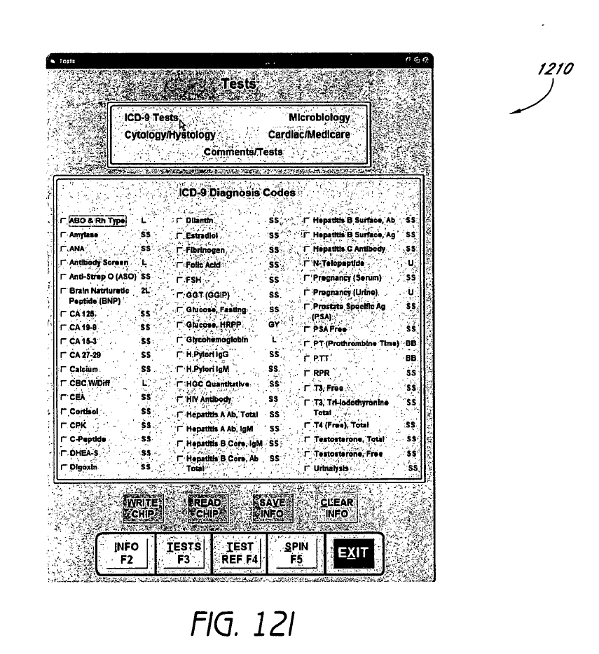

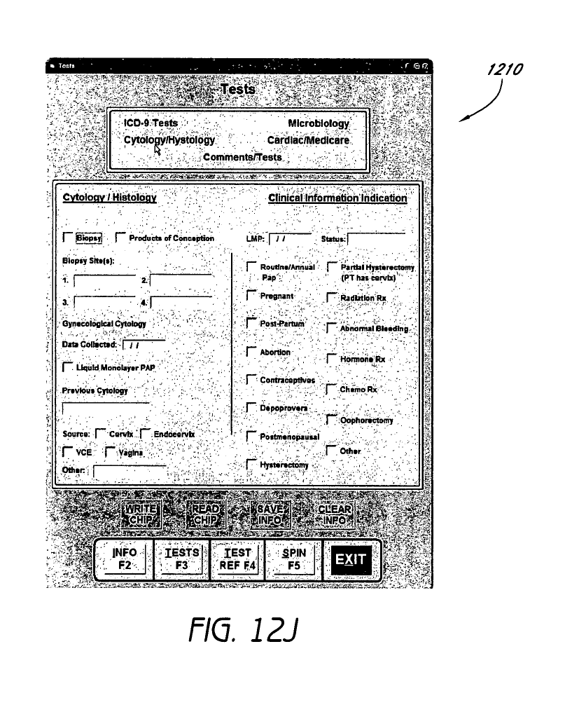

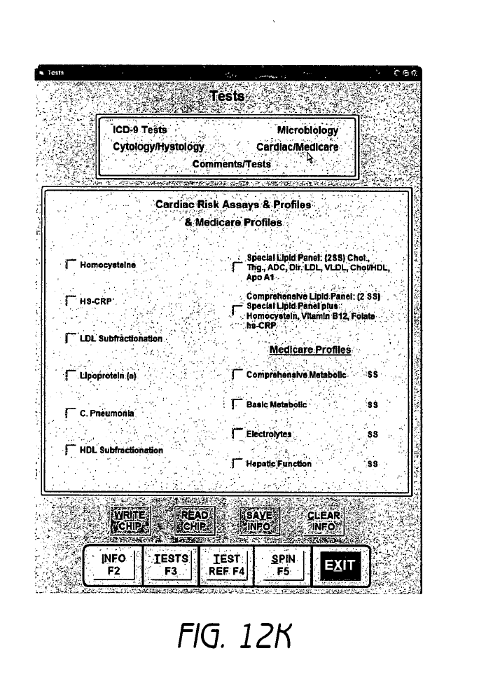

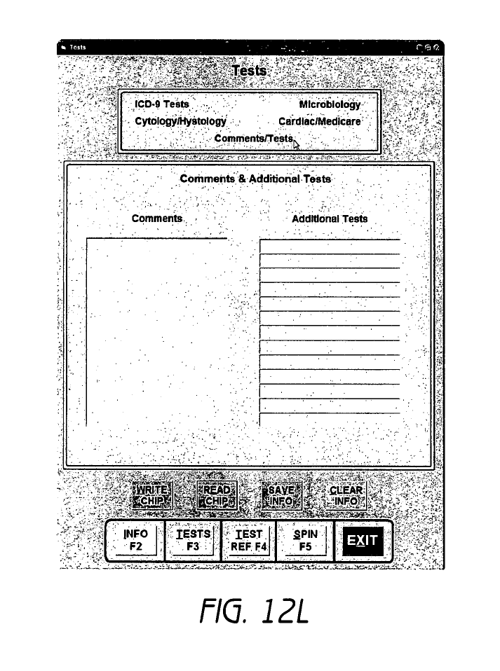

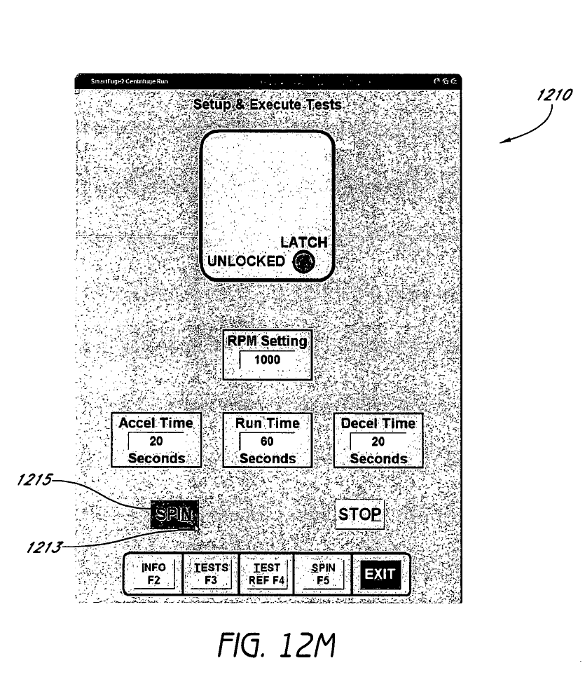

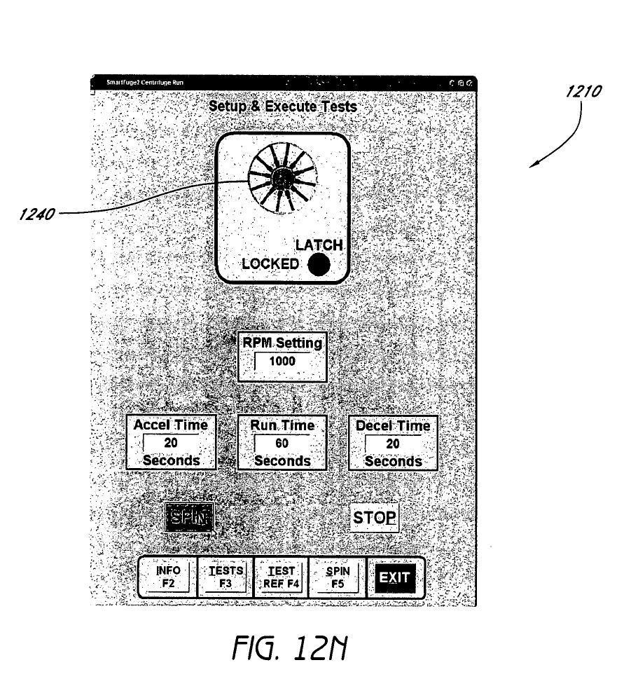

FIGS. 8A-8B illustrate one embodiment of a portable component 700. In this embodiment, the portable component is indicated generally with the reference numeral 800. The portable component 800 has a data projection device 706 in the form of a computer screen 806. The portable component also has a test module 710 in the form of a removable module 810. As illustrated two data input devices 704 are also available, in the form of a computer keyboard 804a and a computer mouse 804b. A sample holder 712 is also available in the form of a test tube receptacle 812. Also illustrated is a sample processor 714 in the form of a centrifuge 814. Computer screen 806 can be used to display various graphical user interfaces, as will be explained in further detail below with reference to FIGS. 12A-12O. The data can be entered into the portable component 800 by means of the computer keyboard 804a, or the computer mouse 804b, for example. Moreover, the portable component 800 can obtain data from an RFID chip 120 when a test tube 110 is inserted into the test tube receptacle 812. The portable component 800 also has a power source not shown, and a signal reception/transmission module not show. Vents 824 are provided to allow air to pass through a plastic housing to the tablet PC that can be embedded in the portable component 800. The vents 824 can also provide a way for sound to travel to and from the tablet PC. Electronic interface ports 828 are provided to allow electronic access to the embedded tablet PC. For example, universal serial bus (USB) input and output ports can be provided. A latch device 822 can be provided on the exterior on the portable component 800 to facilitate security and/or access to the portable component 800. A handle 820 can be located near the latch device 822. A centrifuge access button 816 can be provided near the centrifuge 814 and can open a centrifuge lid 815.

Referring to FIG. 8B, the portable component 800 is illustrated in a different configuration. For example, the removable module 810 has been removed from a receptacle 830 and a removable module handle 811 has been extended from its former recessed position in order to allow the removable module to be lifted out of the receptacle 830. Additionally, the centrifuge access button 816 has been pushed to undue a latch 815 and allow the centrifuge lid 815 to pivot upwards, allowing access to the centrifuge 814. Furthermore, a test tube 110 is illustrated in an orientation that will allow the test tube to fit into the test tube receptacle 812. Located inside the portable component 800, preferably near the bottom of the test tube receptacle, is a data read/write device that may be similar to that described with respect to FIG. 3B. The device can be used to read data from and/or write data to an RFID chip 120 located in the side of the test tube 110. The device can be in electronic communication with the tablet PC, computer mouse 804b, computer keyboard 804a, and/or electronic interface port 828.

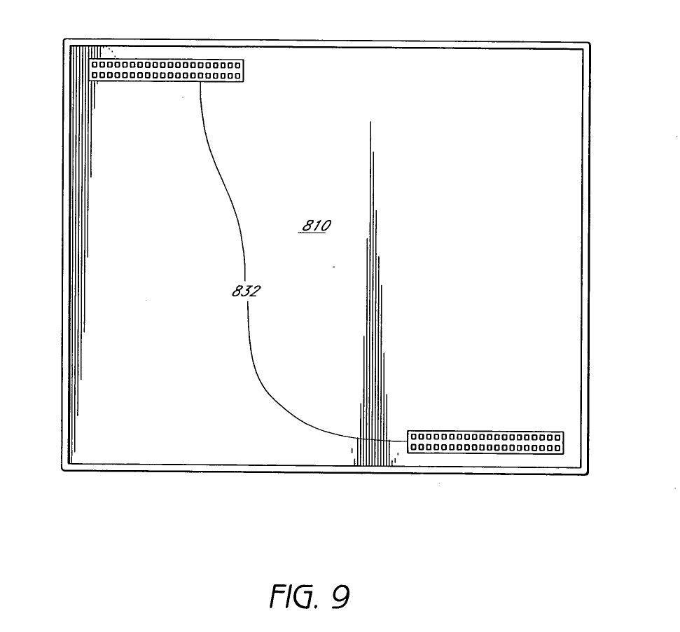

Referring now to FIG. 9, the underside of the removable module 810 is shown. The removable module 810 can include computer interface devices 832. If the removable module 810 comprises electronic circuitry, for example, these computer interface devices 832 can provide a connection between the electronic circuitry and the computer of the portable component 800.

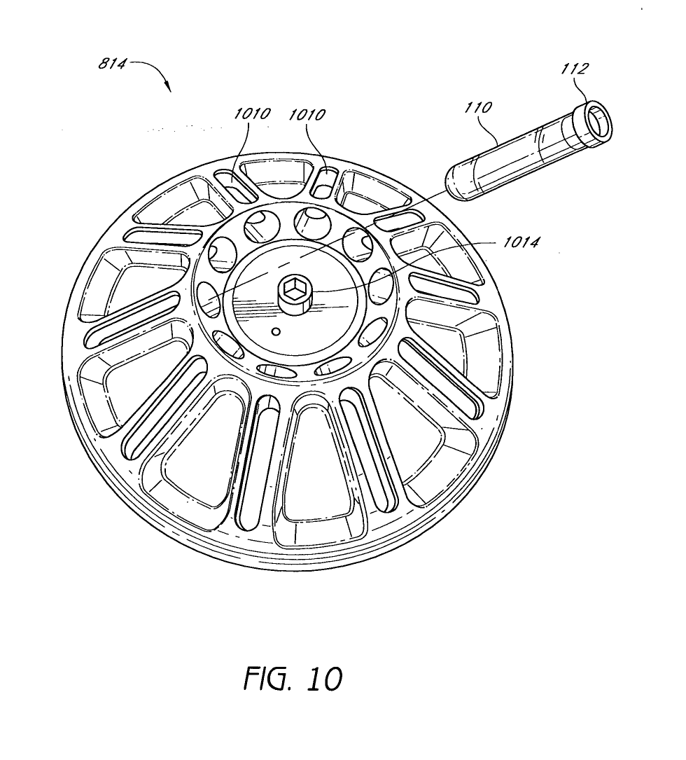

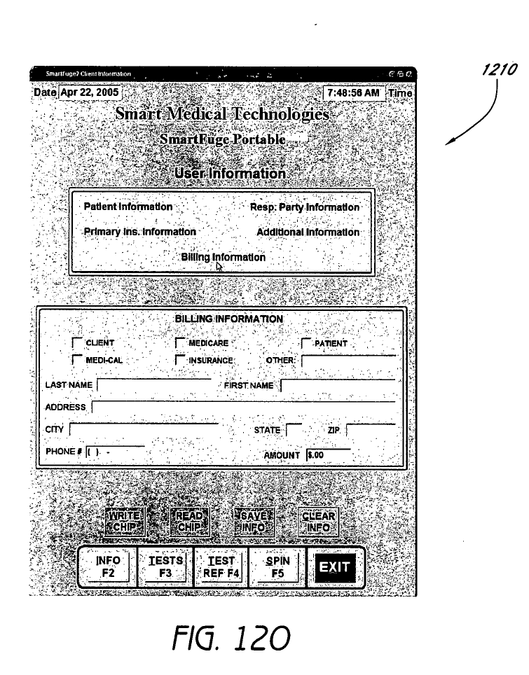

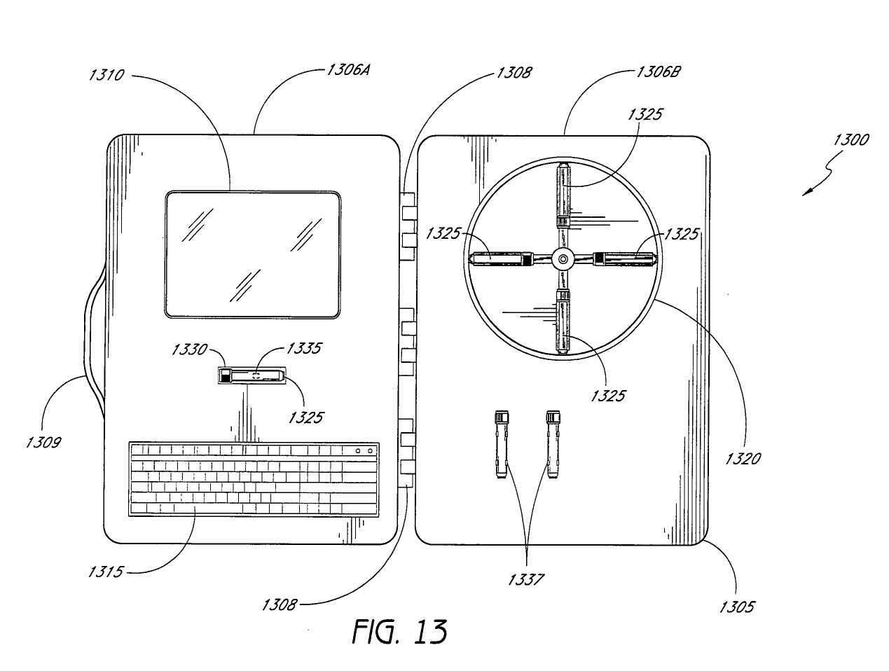

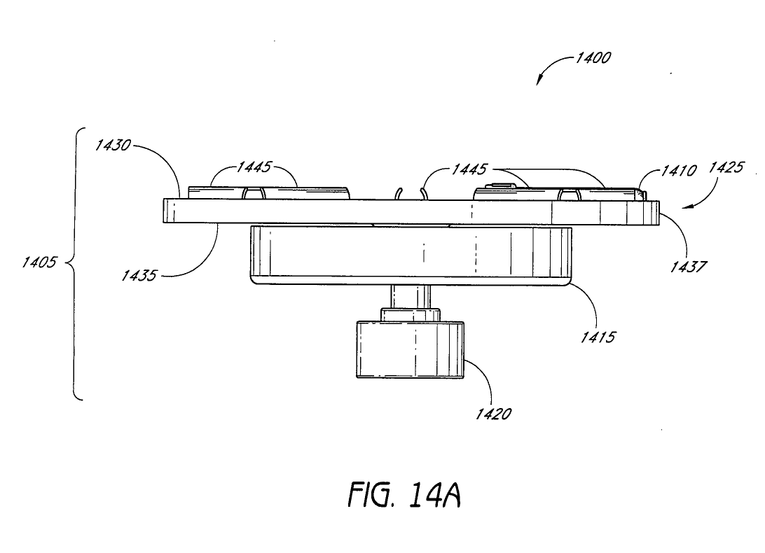

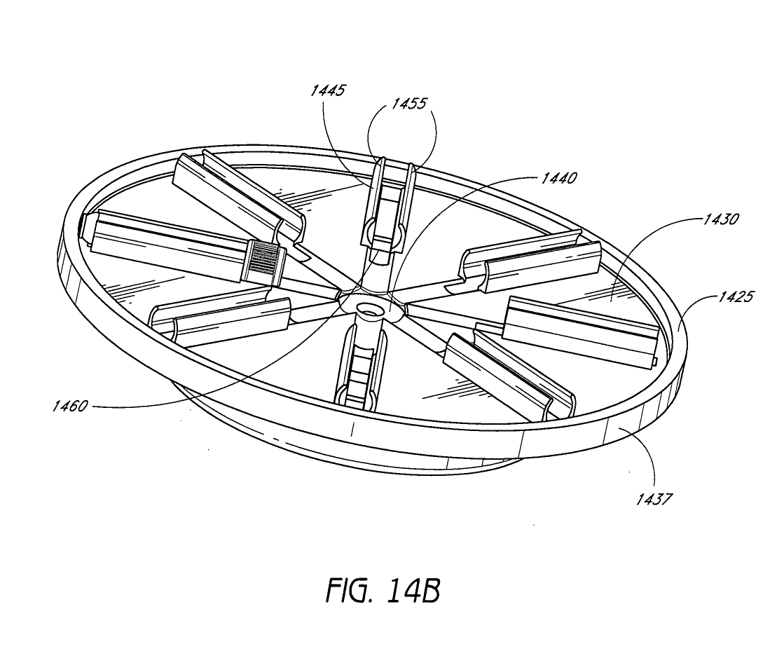

Referring to FIG. 10, the centrifuge 814 is illustrated, with a test tube 110 being oriented in a position ready to be inserted into one of ten test tube slots 1010. The test tube slots 1010 are oriented at an angle that is different from the rotational plane of the centrifuge 814. A fastener 1014 is provided in the center of the centrifuge 814 to ensure that the centrifuge 814 is stable during rotation, but can be removed if appropriate. The centrifuge 814 can be formed from metal, and machined as illustrated. However, many alternative configurations are also possible, and the centrifuge can alternatively orient the test tubes 110 during rotation in many other orientations. An alternative orientation is illustrated in FIGS. 13 and 14, for example. The centrifuge 814 is preferably symmetrical about a central rotational axis. Symmetry can provide the proper balance to allow smooth and even rotation of the centrifuge 814. As the centrifuge 814 rotates, the fluid samples within the test tubes 110 flow such that the constituents of the fluid samples separate into portions according to their relative masses and sizes. In particular, the centrifuge 814 can be designed to tilt the test tubes 110 at an appropriate angle to allow a valve inside the test tubes 110 to permit fluid flow as will be discussed below. The caps 112 help to ensure that the contents of the test tubes 110 will not leak out of the test tubes 110 during centrifugation. The caps 112 and the centrifuge lid 815 help to prevent contamination and enclose the centrifugation process to improve sanitation and safety. As discussed further below, the centrifuge can be controlled using an integrated tablet PC, including the computer screen 806, and the computer mouse 804b, and the computer keyboard 804a. Alternatively, the centrifuge 814 can be controlled with dedicated buttons located on the portable component 800,

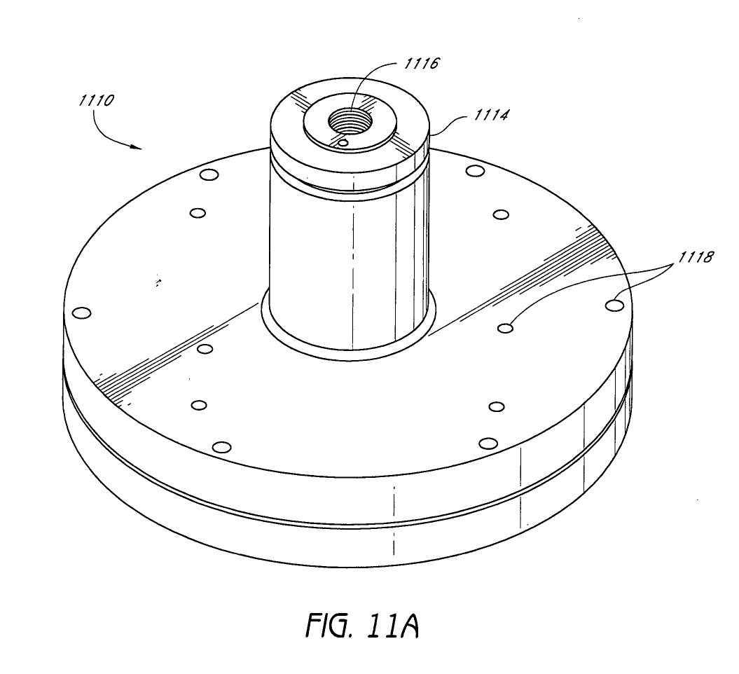

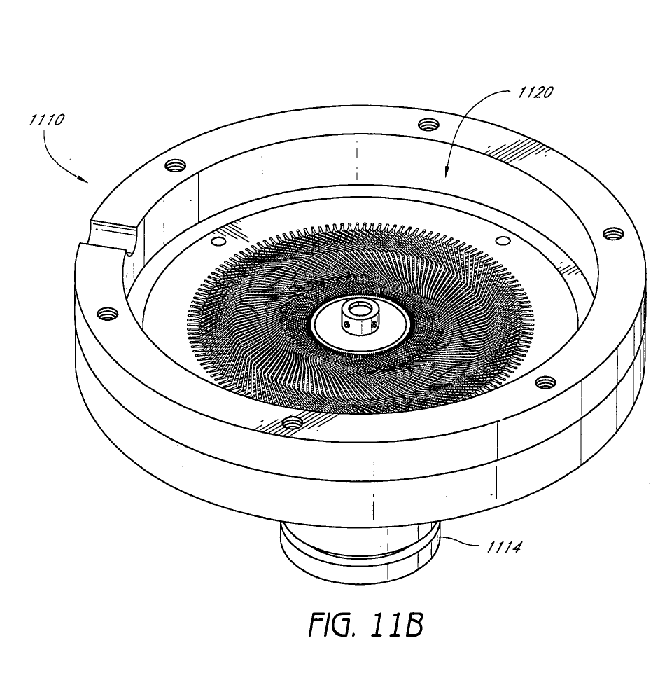

Referring to FIG. 11A, a centrifuge motor housing 1110 is illustrated. The centrifuge motor housing has a central post 114, with a threaded bore 1116. The central post 114 is generally located parallel to the axis of rotation of the motor not shown, and the centrifuge 814. The centrifuge motor housing 1110 also has bolt holes 1118 that can help provide structural stability when bolts are inserted therein.

Referring to FIG. 11B, the centrifuge motor housing is depicted as seen from the other side. The centrifuge motor housing 1110 comprises a motor nest 1120 where a “pancake” motor (not shown) can be inserted. The pancake motor can provide the rotational force to turn the centrifuge 814. The centrifuge 814 and the centrifuge motor housing 1110 can be coupled together to provide a stable rotatable structure that can be inserted into the portable component 800 and fully integrate therewith.

FIGS. 12A-12O depict screenshots of a graphical user interface in various modes that can be used with a portable module 700. In particular, a graphical user interface 1210 can be employed to communicate data from a data projection device 706 that is part of a user interface 702, as illustrated in FIG. 7. Furthermore, the graphical user interface 1210 can be employed with the device illustrated in FIG. 8. For example, the orientation of the screenshots of the graphical user interface 1210 is compatible with a tablet PC in the portrait orientation. FIG. 12A illustrates a view of the graphical user interface 1210 showing the date in the upper left-hand corner, the time in the upper right-hand corner, a user information box 1212, a patient information box 1214, and various button controls 1216. The user information can include, as illustrated, patient information, responsible party information, primary insurance information, additional information, and billing information.

In some embodiments, each of these subcomponents of user information can be presented on a different page of the graphical user interface 1210. The patient information box 1214 provides fields for the following information: patient last name, patient first name, address, city, state, zip code, phone number, social security name, sex, birth date, and patient identification. The buttons 1216 can be used to navigate between various portions of the data, or they can be used to activate functions of the portable module 700. Functions that can be performed and/or activated using these buttons include: writing data to the RFID chip 120, reading the data from the RFID chip 120, saving the information to an independent database, clearing information from the fields displayed on the graphical user interface 1210, activating a spinning motion of a centrifuge, for example, locating test information, and exiting the system.

Referring to FIG. 12B, a similar view to that depicted in FIG. 12A is shown, but with an additional information box 1218. The additional information that can be entered or viewed can comprise: physician name; e-mail; identification; address, city, state, zip code, and phone number; and information relating to the status of the patient, including whether or not the patient was fasting, and the date and time of specimen collection. In addition, there is a field for entering the name of the person who drew the blood or collected the sample.

Referring to FIG. 12C, responsible party information can be displayed and/or entered. For example, the last and first name of the responsible party, the address, city, state, zip code, phone number, social security number, and employer of the responsible party can all be entered and/or displayed.

Referring to FIG. 12D, the primary insurance information screen is depicted. The name of the primary information holder, as well as the address, city, state, zip code, phone number, policy number, group number, subscriber number, and relationship to the patient can all be displayed and/or entered.

Referring to FIG. 12E, a portion of the graphical user interface 1210 is displayed that is similar to the graphical user interface 510 depicted in FIG. 5E. In particular, a test reference dictionary is provided that can provide information relating to numerous tests that are available to help care providers. Fields are provided for locating test information alphabetically, searching according to keywords or letters, and indicating which lab tests have been selected. FIG. 12F shows another view of the graphical user interface 1210 that is displaying test reference information. In the upper portion a blood test number 82009 is indicated and the name, Acetone, Blood, is given. Further information is also provided below, including the notation “3 ml Whole Blood Gray Top Tube (Sodium Fluoride).” Further information can also be provided to the healthcare worker, for example, the note relating to uncapping the tube and centrifugation. Below is a list of possible blood tests that have been arranged alphabetically. In the selected lab tests field 1222, the selected test 82009 appears for reference. FIG. 12G illustrates how a second lab test can be added to the selected lab tests list. In this case, the tests numbered 82735 for Fluoride, Serum.Plasma has been selected. The search field 1220 has been used to locate this test, as indicated.

Referring to FIG. 12H, a test box 1230 is illustrated, which includes the subtest categories of ICD-9 tests, microbiology tests, cytology/histology tests, cardiac/Medicare tests, and comments/tests. These subcategories each can correspond to a separate screen in the graphical user interface 1210. As illustrated, the various microbiology tests that are available are as follows: Throat Culture, Sputum Culture, Stool Culture, Occult Blood, Ova and Parasite, Herpes Culture, Myco/Ureaplasma, Misc. Culture, Beta-Hemo Strep, Vaginal Culture, GC Only Culture, Urethral Culture, Gram Stain, Urine Culture, Eye Culture, Ear Culture, Chlamydia NAA Swab, Gonorrhea NAA Swab, Chlamydia NAA Urine, Gonorrhea NAA Urine, Wet Mount, Naso-Pharinx C/S, Anarobic Culture, And Vaginitis DNA Probe.

Referring to FIG. 12I, The graphical user interface 1210 provides the option of selecting and/or being informed of a previous selection, for the following ICD-9 diagnosis tests: ABO & Rh type (L); Amylase (SS); ANA (SS); Antibody Screen (L); Anti-Strep O (ASO) (SS); Brain Natriuretic Peptide (BNP) (2L); CA 125 (SS); CA 19-9 (SS); CA 15-3 (SS); CA 27-293 (SS); Calcium (SS); CBS W/Diff (L), CEA (SS); Cortisol (SS); CPK (SS); C-Peptide (SS); DHEA-S (SS); Digoxin (SS); Dilantin (SS); Estradiol (SS); Fibrinogen (SS); Folic Acid (SS); FSH (SS); GGT (GGIP) (SS); Glucose, Fasting (SS); Glucose, HRPP (GY); Glycohemoglobin (L); H. Pylori IgG (SS); H. Pylori IgM (SS); HGC Quantitative (SS); HIV Antibody (SS); Hepatitis A Ab, Total (SS); Hepatitis A Ab, IgM (SS); Hepatits B Core, light (SS); Hepatitis B Core, Ab Total (SS); Hepatitis B Surface, Ab (SS); Hepatitis B Surface, Ag (SS); Hepatitis C Antibody (SS); N-Telopeptide (U); Pregnancy (Serum) (SS); Pregnancy (Urine) (U); Prostate Specific Ag (PSA) (SS); PSA Free (SS); PT (Prothrombine Time (BB); PTT (BB); RPR (SS); T3, Free (SS); T3, Tri-lodothyronine Total (SS); T4 (Free), Total (SS); Testosterone, Total (SS); Testosterone, Free (SS); and Urinalysis (SS).

Referring to FIG. 12J, a portion of the graphical user interface 1210 can resemble the graphical user interface 510 illustrated in FIG. 5H. As illustrated, a biopsy and/or products of conception box can be checked. Biopsy sites can also be indicated in the four fields shown. Gynecological cytology data collection date can be entered, a liquid monolayer PAP box can be checked, and data relating to previous cytology can be entered. Additionally, a source can be indicated such as a cervix, endocervis, VCE, vagina or other period. Regarding the clinical information indication portion of the cytology/histology tab 560, LMP data and status data can be entered. In addition, the following boxes can be checked: Routine/Annual Pap, Pregnant, Post-Partum, Abortion, Contraceptives, Depoprovera, Postmenopausal; Hysterectomy; Partial Hysterectomy (PT has cervix); Radiation Rx; Abnormal Bleeding; Hormone Rx; Chemo Rx; Oophorectomy; or Other.

Referring to FIG. 12K, a portion of the graphical user interface 1210 can resemble the graphical user interface 510 illustrated in FIG. 51. Information relating to cardiac risk assays and profiles and Medicare profiles can be entered at this tab. For example, the following cardia risk assays can be selected: Homocysteine; HS-CRP; LDL Subfractionation; Lipoprotein (a); C. Pneumonia; HDL Subfractionation; Special Lip Panel; and Comprehensive Lip Panel. The following Medicare profiles can also be selected: Comprehensive Metabolic (SS); Basic Metabolic (SS); Electrolytes (SS); and Hepatic Function (SS).

Referring to FIG. 12L, a portion of the graphical user interface 1210 can resemble the graphical user interface 510 illustrated in FIG. 5L. This tab provides data entry fields for comments from the user on the left, and a list of fields at the right for additional tests to be performed. If a physician, nurse, or other healthcare provider wishes to indicate a unique or unlisted test, the test may be described in one of these fields without the healthcare professional having to select from a predetermined database.

Referring to FIG. 12M, a portion of the graphical user interface 1210 can provide an interface for the user to control the centrifuge 814. Settings for the RPM acceleration time, run time, and deceleration time can all be entered. In FIG. 12M, 1000 revolutions per minute has been selected, an acceleration time of 20 seconds has been selected, a run time of one minute has been selected, and a 20-second deceleration time has been selected. The cursor 1213 is located over the spin button 1215, which can be used to activate the centrifuge 814. FIG. 12N illustrates the graphical user interface 1210 when the centriftige 814 is operating. An icon 1240 of a spinning centrifuge is illustrated. Furthermore, the illustration indicates that the device is locked and therefore prepared to operate in spin mode.

Referring to FIG. 12O, the billing information portion of the user information is displayed. The data that can be displayed and/or entered from this portion of the graphical user interface 1210 is as follows. The entity to be billed (such as the client, Medicare, the patient, Medi-Cal, insurance, and/or other) can be indicated. Furthermore, information relating to that entity can be displayed and/or entered, for example, last name, first name, address, city, state, zip code, and phone number. Furthermore, the amount to be billed can be entered and/or displayed.

FIG. 13 illustrates one embodiment of a sample processing system, indicated generally by the reference numeral 1300. The sample processing system 1300, which can take many forms, is an example of another embodiment of the portable component 700 described above. The sample processing system 1300 can fill the same needs as those filled by the portable component 700. For example, biological samples can rapidly decay after being removed from a patient. Accordingly, the processing provided by the sample processing system 1300 places the sample in a stable state so that it can be transported from the sample-taking location to another location and/or stored prior to further processing. In some applications, the sample processing system 1300 is particularly useful for processing whole blood. One skilled in the art will recognize, however, that the sample processing system 1300 can be used with a wide variety of samples, including biological and non-biological samples.

With continued reference to FIG. 13, the sample processing system 1300 is generally enclosed by a housing 1305. In one embodiment, the housing 1305 has a clamshell configuration. For example, the housing 1305 can be formed with two opposing halves 1306A and 1306B that are joined by hinges 1308 along corresponding edges of the two opposing halves 1306A and 1306B. In this configuration, the hinges 1308 permit the opposing halves 1306A, 1306B and the housing 1305 to move between a closed position and an open position. In the open position, the housing 1305 exposes the contents of thereof for use. In the closed position, the housing 1305 substantially encloses the contents thereof. Other types of housings also can be used that provide access to at least some of the components of this or other embodiments of the sample processing system 1300.

Preferably, the sample processing system 1300, and the housing 1305 that encloses the components thereof, is portable. For example, the system 1300 can be easily transported by a user and used where convenient, e.g., generally where a patient is found. To assist in providing portability, the housing 1305 preferably has one or more handles 1309. The system 1300 also preferably is relatively small and light-weight. In one embodiment, the housing 1305 is generally the size and shape of a standard sized briefcase.

Preferably, the system 1300 also includes a user interface 1310 and a data entry device 1315. In one embodiment, the user interface 1310 comprises a visual display, an audible display, or a combination visual/audible display that displays sample information. The terms “sample information” and “processing information” are used in their ordinary sense and mean, without limitation, information related to a patient, a sample, a sample processing device or method, or any other information useful for processing a sample. A visual display can include an analog dial, a digital read-out, one or more light emitting diodes, a liquid crystal display, or any other suitable visual display. An audible display can include a speaker or any other suitable audible device. In the embodiment shown in FIG. 13, the user interface 1310 comprises a visual monitor.

The data entry device 1315 can include any mechanism for entering data for temporary or permanent storage. In the illustrated embodiment, the data entry device 1315 comprises a keyboard. However, the data entry device 1315 can be any suitable device that permits the user to enter and/or to edit processing information, e.g., a mouse, a microphone, etc. In another embodiment, the user interface 1310 and the data entry device 1315 are integrated, e.g., as a touch-screen display that is manipulated by a stylus or by a user's finger.

The sample processing system 1300 also includes a centrifuge 1320. The centrifuge 1320 preferably is compact in construction. In one embodiment, the centrifuge 1320 has a low profile, whereby the centrifuge 1320 operates in a relatively small volume. In one embodiment, the centrifuge 1320 is configured with a low profile by providing that all components thereof are maintain a fixed distance from an outer side of the opposing half 1306B of the housing 1305 throughout the operation of the centrifuge 1320. For example, when the housing 1305 is laid open on a horizontal surface, all the component of the centrifuge 1320 remain in a same horizontal plane throughout the centrifuge process. Further details of one embodiment of the centrifuge 1320 are set forth below in connection with FIGS. 14A-14B.

While the embodiment illustrated in FIG. 13 includes the centrifuge 1320, other devices that process a sample can be incorporated into the sample processing system 1300. Also, as discussed above, the system 1300 can be used in connection with a variety of samples, including biological samples (e.g., whole blood) and non-biological samples.

The sample processing system 1300 also includes a sample storage vessel 1325 and a data transfer device 1330. In one embodiment, the sample storage vessel 1325 includes a data storage element 1335. As used herein, the term “sample storage vessel” is used in its ordinary senses and means, without limitation, any container for holding a sample, e.g., a test tube, a flask, or any other suitable sample holding container that can contain a sample for a relatively long period. However, a test tube is one sample storage vessel that is particularly well suited for a centrifuging process. Preferably, the data transfer device 1330 can be coupled with the data storage element of the sample storage vessel 1325, whereby the processing information can be stored and kept with the sample storage vessel 1325.

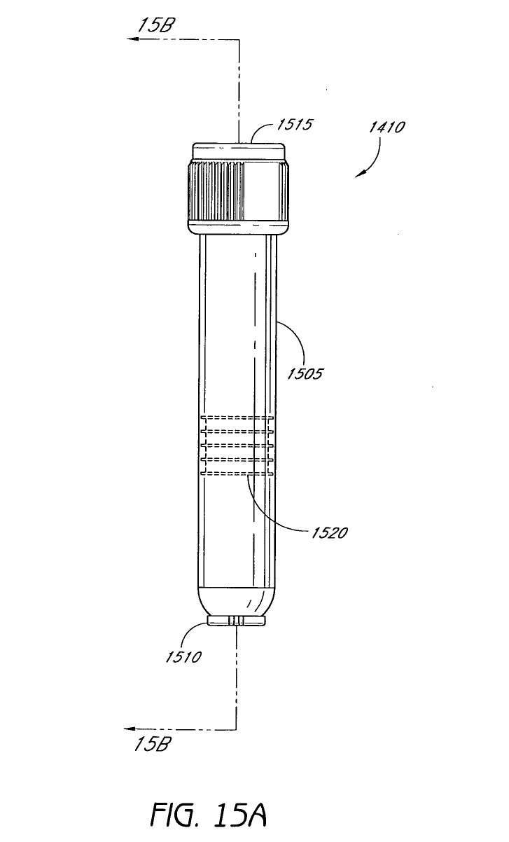

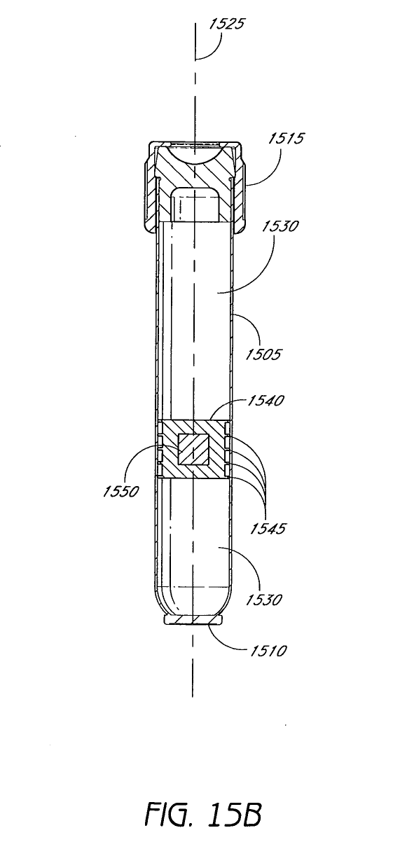

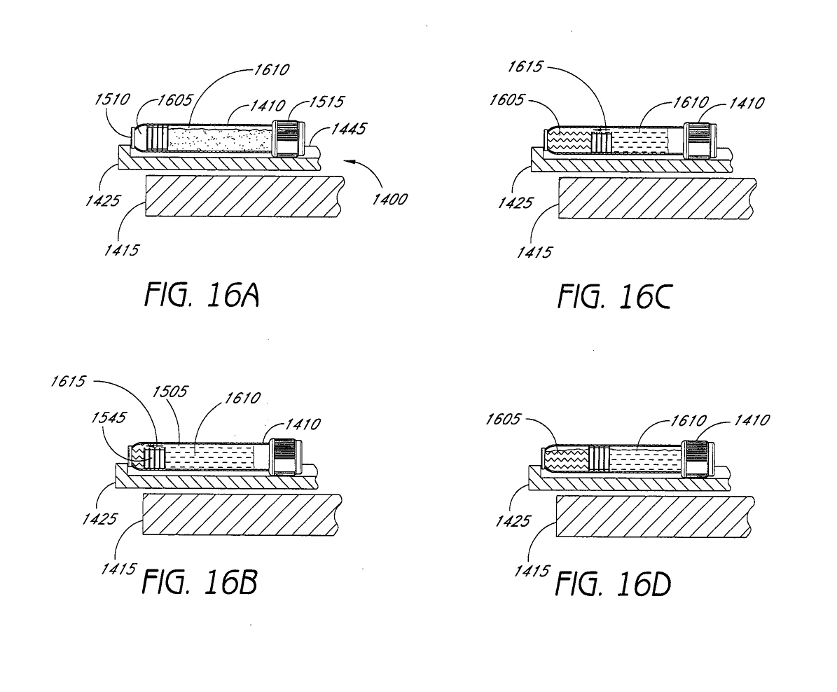

The data storage element 1335 can be any device that can receive data and store data permanently. The term “permanent” and its variants is used herein in its ordinary sense and means, without limitation, that data is retained for an extended time, e.g., at least for the useful life of a sample storage vessel 1325, as described herein. Preferably, the data storage element 1335 is an electronic element, e.g., an element to which data is written electrically or magnetically. Further details of the sample storage vessel 1325 are set forth below in connection with FIGS. 15 and 16.

In one embodiment, the data transfer device 1330 comprises a slot into which the sample vessel 1325 is inserted. However, the data transfer device 1330 can be configured to transmit data to the data storage element 1335 while the associated sample storage vessel 1325 is coupled to the centrifuge 1320. For example, in one embodiment, data is transferred to the data storage element 1335 after the centrifuge 1320 completes operation. In another embodiment, data is transferred to the data storage element 1335 before the centrifuge 1320 completes operation. In another embodiment, data is transferred to the data storage element 1335 while the centrifuge 1320 is operating.

The housing 1305 is configured to enclose, at least partially, each of the foregoing components of the sample processing system 1300. The housing 1305 can also be provided with locations to store one or more sample storage vessels 1325 either before or after the sample storage vessel 1325 has been filled with a sample. For example, one ore more storage clamps 1337 can be provided to hold sample storage vessels 1325. Other components can also be included in the sample processing system 1300, such as syringes and catheters for accessing and transferring whole blood from a patient to the sample storage vessel 1325.

FIG. 14A shows one embodiment of a centrifuge system 1400. The centrifuge system 1400 includes a centrifuge 1405, a sample vessel 1410, and a sample vessel valve actuator 1415. The centrifuge 1405 is configured to receive the sample vessel 1410 containing a sample and to process the sample. As discussed in more detail below in connection with FIGS. 16A-16D, the sample vessel valve actuator 1415 manipulates a valve located in the sample vessel 1410 to facilitate and to maintain separation of components of the sample (e.g., whole blood) in the centrifuge 1405.

The centrifuge 1405 includes a motor 1420 and a wheel 1425 coupled to the motor 1420. The wheel 1425 includes a first surface 1430, a second surface 1435, an outer periphery 1437, and a hub 1440. The hub 1440 includes the inner-most portion of the wheel 1425, extends from the second surface 1435 of the wheel 1425, and is coupled with the motor 1420. A plurality of sample vessel clamps 1445 are located on the first surface 1430 of the wheel 1425. The hub 1440 is coupled with a shaft of the motor 1420 and rotation of the shaft is transferred to the wheel 1425 through the hub 1440. Thus, the motor 1420 can cause the wheel 1425 and the sample vessel clamps 1445 located thereon to rotate.

In the illustrated embodiment, each of the sample vessel clamps 1445 includes a pair of jaws 1455 and an elongate recess 1460 formed on the first surface 1430 of the wheel 1425. The elongate recess 1460 preferably extends parallel to a radius of the wheel 1425 and has an arcuate transverse cross-section. In one embodiment, the jaws 1455 are formed as a pair of members that extend generally upwardly from the first surface 1430 of the wheel 1425. The elongate members extend along the elongate recess 1460 and have an arcuate transverse cross-section. Thus, in one embodiment, the jaws 1455 and the recess 1460 at least partially define a cylindrical volume that extends from the outer periphery 1437 to a location between the outer periphery 1437 and the hub 1440.

The upper-most portion of the jaws 1455 are spaced apart by a distance that is less than the transverse dimension of the sample vessel 1410. Thus, to insert the sample vessel 1410 into the sample vessel clamp 1445, the sample vessel 1410 must be urged against the upper-most portion of the jaws 1455 to spread the jaws 1455. Once the jaws 1455 are spread, the sample vessel 1410 can be advanced into the cylindrical volume defined by the jaws 1455 and the recess 1460. Once in the cylindrical volume, the sample vessel clamp 1445 applies pressure to the sample vessel 1410, which prevents the sample vessel 1410 from moving. In one embodiment, one end of the jaws 1455 located is adjacent the outer periphery 1437 so that when a sample vessel 1410 is positioned in the jaws 1455, a portion of the sample vessel 1410 abuts against the outer periphery 1437 to prevent the sample vessel 1410 from moving radially outwardly when the wheel 1425 is rotated.

While any suitable clamp that secures the sample vessel 1410 in position on the centrifuge 1405 can be used, the sample vessel clamp 1445 is particularly advantageous. For example, the sample vessel clamp 1445 has no moving parts that alter the orientation of the sample vessel 1410 during operation of the centrifuge system 1400. Thus, the sample vessel clamp 1445 can be easily manufactured. In addition, having no moving parts, the longitudinal axis of the cylindrical volume defined by the sample vessel clamp 1445, and the longitudinal axis of the sample vessel 1410 held thereby can be maintained in a single plane throughout the operation of the centrifuge 1420. For this and other reasons discussed above, the centrifuge 1420 can be made with a very low profile.

In the illustrated embodiment, the centrifuge 1405 comprises eight sample vessel clamps 1445 that are located on the first surface 1430 of the wheel 1425. Other numbers of sample vessel clamps 1445 can be provided. For example, the centrifuge 1320 of FIG. 13 comprises four sample vessel clamps.

FIGS. 15A and 15B illustrate one embodiment of a sample vessel 1410. The sample vessel 1410 includes a cylindrical container 1505, a data storage element 1510, a closure member 1515, and a valve 1520. The cylindrical container 1505 extends along a sample vessel longitudinal axis 1525 (See FIG. 15B) and has an inner perimeter of a selected size. The cylindrical container 1505 defines a sample volume 1530. The cylindrical container 1505 preferably is made of a material that has sufficient durability to be processed in the centrifuge 1405 (e.g., to be inserted into the sample vessel clamp 1445 and rotated by the centrifuge 1405), and in a variety of other sample processing devices. The cylindrical container 1505 preferably is made of a material that has sufficient durability to be transported between a plurality of testing stations within a laboratory or to be transported between laboratories.

The data storage element 1510 is a device that stores processing information related the sample contained in the sample vessel 1410. In one embodiment, the data storage element 1510 comprises a permanent memory device. As discussed above in connection with FIG. 13, the data storage device 1510 is configured to couple with a data transfer device that imparts relevant processing information to the data storage device 1510. The memory provided by the data storage device 1510 is a persistent memory, wherein the information stored therein remains with the sample vessel 1410 throughout the useful life of the sample vessel 1410.

The persistent memory of the data storage device 1510 provides many advantages. For example, a great deal of processing information is generated in connection with typical biological samples. For example, the sample is taken from a particular patient under specific circumstances that may be relevant to further analysis. Some samples may require processing within a specified time from the taking of the sample. Thus, the time at which the sample was taken is relevant processing information to be saved and kept with the sample. Also, most samples are taken to perform one or more tests specified by a medical professional. It is important that the sample be directed to the correct test because the sample usually will be destroyed during the test. If the wrong test is performed, the patient will be required to return to provide an additional sample. Worse yet, a delay may result, which can be prevent timely diagnosis and delay treatments for which time is of the essence. Thus, the prescribed test is relevant processing information to be kept with the sample. Also, most tests generate a test result that is used to analyze the health of the patient and/or to inform a medical professional as to the treatment required. The result must be matched with the sample, or at least matched with the patient from whom the sample was taken, to avoid having the correct treatment indicated by the test being given to the wrong patient.

Without the data storage element 1510, the relevant processing information normally would be hand-written on a label, which can be lost, be rendered unreadable, or otherwise become inoperative. Moreover, as discussed in more detail below, existing test tubes used to store biological samples seldom remain with the sample for very long. Rather the sample is very quickly transferred to another container. Accordingly, the processing information discussed above must be transferred from one label to another label each time a sample is transferred from one test tube to another test tube. The transfer of the sample and the transcription of the processing information can provide many opportunities for the sample and the processing information to become corrupted. In contrast, the data storage element 1510 preferably remains at all times with the sample vessel 1410 and does not require any data transcription. Rather, the data storage element 1510 can interact with sample processing equipment to update data stored therein. This enables the processing information to be accessible and retrievable for further reference and use. Further features of the sample vessel 1410 discussed below prolong its life during handling and storage of a single sample.

In one embodiment, the closure member 1515 is a standard stopper for a test tube. The closure member 1515 is preferably made of a bioconipatible material so that the sample contained in the sample volume will not be corrupted by interaction with the closure member 1515. In one embodiment, the closure member 1515 is knurled around an upper side edge, e.g., having ridges to facilitate gripping by a user. Also, the closure member 1515 preferably is color coded, whereby the color of the closure member 1515 indicates, at least in part, how the sample vessel 1410 is to be handled or processed.

FIG. 15B shows the structure of one embodiment of the valve 1520 in greater detail. The valve 1520 includes a plug member 1540 that has an outer perimeter of a selected size. In one embodiment, the plug member 1540 is a cylindrical member that has a diameter that is less than the inner perimeter of the cylindrical container 1505. The valve 1520 also includes five flexible rings 1545 that extend around the outer perimeter of the cylindrical plug member 1540. The rings 1545 are configured to form a seal with the inner wall of the cylindrical container 1505. For example, in one embodiment, the rings 1545 are flexible members that have an outer perimeter that is less than the perimeter of the inner wall of the cylindrical container 1505. The seal formed between the rings 1545 and the cylindrical container 1505 is discussed in greater detail below.

While five flexible rings 1545 are shown, a lesser number can also be employed. For example, one or more flexible rings 1545 can be provided around the outer perimeter of the cylindrical plug member 1540. Also, the rings 1545 can be eliminated entirely if the plug member 1540 is configured to form a seal with the inner wall of the cylindrical container 1505. While fewer than five flexible rings 1545 can be provided, the illustrated embodiment is particularly useful for isolating components of a sample (in the sample volume 1530 in that together the rings 1545 provide a series of barriers, which in turn provides greater isolation.

The valve 1520 also includes a ferrous material 1550 is a monolithic member that is embedded within the plug 1540. In one embodiment, the ferrous material 1550 is embedded in the plug 1540. In the illustrated embodiment, the ferrous material 1550 comprises a cylindrical member that is centered on the sample vessel longitudinal axis 1525 when the valve 1520 is closed, as discussed below. The ferrous material 1550 can take other shapes as well. For example, several smaller, distinct ferrous portions can be provided within the plug 1540. In one embodiment, an array of ferrous portions are provided within the plug 1540. In some embodiments, the array of ferrous portions are uniformly distributed within the plug 1540. In other embodiments, the array of ferrous portions are unevenly distributed. The position of the ferrous material 1550 and its distribution may provide advantages in connection with the valve actuator 1415, discussed in more detail below.

The valve 1520 in the sample vessel 1410 is actuated by the valve actuator 1415 during centrifugation to facilitate isolation of the various components of the sample. As discussed above, in one embodiment, the valve 1520 comprises a ferrous material, or a ferrous portion, embedded within the plug member 1540 and the valve actuator 1415 comprises an electromagnet. As described in more detail below in connection with FIGS. 16A-16D, the plug member 1540 interacts with the electromagnet of the valve actuator 1415. This interaction causes the valve 1520 selectively to be opened and closed. When open, the valve 1520 allows the flow of the sample around the valve 1520. When closed, the valve 1520 blocks the flow of sample around the valve 1520. Also, as discussed below, the interaction between the electromagnet of the valve actuator 1415 and the ferrous material within the valve 1520 causes the valve 1520 to be moved, if desired, from a first position in the sample volume 1530 to a second position in the sample volume 1530. In some applications, the second position is determined based on properties of the sample. For example, in some centrifugation processes a predictable percentage of whole blood is red blood cells. Thus, the valve 1520 can be moved during centrifugation to a position that corresponds to the percentage of red blood cells in the whole blood.

FIGS. 16A-16D further illustrate the operation of one embodiment of the centrifuge system 1400. FIG. 16A shows a portion of a partial cross-section of the centrifuge system 1400 through one of the sample vessel clamps 1445. In this figure, the wheel 1425 of the centrifuge 1405 has not yet begun to rotate. As can be seen, a sample vessel 1410 having a sample of whole blood is positioned in a sample vessel clamp 1445. Also, the electromagnet of the valve actuator 1415 has not been energized, so the valve 1520 is closed. The valve 1520 is located in a first position in the sample vessel 1410. The first position is adjacent the bottom of the sample vessel 1410. When closed, the plug member 1540 of the valve 1520 is centered on the sample vessel longitudinal axis 1525 and the rings 1545 extend outwardly form the plug member 1540 to engage the inner wall of the cylindrical container 1505. Thus, each of the rings 1545 forms a seal with the inner wall of the cylindrical container 1505. Each of the rings 1545 also form a portion of a seal the between a first chamber 1605, defined between the valve 1520 and the data storage element 1510, and a second chamber 1610, defined between the valve 1520 and the closure member 1515. As discussed in more detail below, the relative size of the first chamber 1605 and the second chamber 1610 can change during use of the centrifuge system 1400. The multiple rings 1545 of the valve 1520 provide some redundancy and improve the isolation of the first chamber portion 1605 and the second chamber portion 1610. In FIG. 16A, a sample of whole blood is located in the second chamber portion 1610.

FIG. 16B is similar to FIG. 16A, but shows the valve 1520 opened and the wheel 1425 of the centrifuge 1405 being rotated. To open the valve 1520, the electromagnet of the valve actuator 1415 is energized. This causes the ferrous material 1550 embedded in the plug member 1540 to be displaced in a direction that is generally transverse to the longitudinal axis of the sample vessel longitudinal axis. For example, as shown in FIG. 16B, the plug member 1540 can be urged transversely toward the valve actuator 1415 by the interaction of the magnetic field and the ferrous material 1550 embedded in the plug member 1540. This movement causes a space to be created between the rings 1545 and the inner surface of the cylindrical container 1505, which space provides fluid communication between the first chamber portion 1605 and the second chamber portion 1610. When the valve 1520 is opened, the sample (e.g., the whole blood) in the sample vessel 1410 can move between the valve 1520 and the inner surface of the cylindrical container 1505, as indicated by the arrow 1615. When the valve 1520 is open, the whole blood, or at least a higher density component thereof, flows from the second chamber 1610 to the first chamber 1605. Thus, the components of the whole blood having higher density are separated from the components of the whole blood having a lower density.

FIG. 16C illustrates that the valve 1520, in some embodiments, is also movable within the sample volume 1530 of the sample vessel 1410. In one embodiment, the strength and orientation of the magnetic field generated by the electromagnet of the valve actuator 1415 and the size and shape of the ferrous material 1550 are selected to cause the valve 1520 to move within the sample volume 1530. As can be seen in FIG. 16C, the valve 1520 has moved from the first position adjacent the bottom of the sample vessel 1410 to the second, which is a position closer to the closure member 1515 than is the first position of the valve 1520. As discussed above, this position can be selected based on the expected amount of higher density material to be separated from lower density material. For example, in one embodiment, the second position is selected to provide a volume between the valve 1520 and the bottom of the sample vessel 1410 that corresponds to the expected volume of red blood cells in a typical sample of whole blood.

FIG. 16D illustrates the end of the centrifugation process carried out in the centrifuge system 1400. At this stage, the electromagnet of the valve actuator has been de-energized, which has caused the valve 1520 to close. As described above, when the valve is closed, the rings 1545 engage the inner surface of the cylindrical container 1505. A seal is thereby created between the first chamber 1605 and the second chamber 1610. This seal effectively isolates the first and second chambers 1605, 1610. Thus, in the case of whole blood that has been centrifuged, the red blood cells can be isolated in the first chamber 1605 from the rest of the blood, which is in the second chamber 1610.

Although the centrifuge system 1400 includes a valve actuator that has a electromagnet, other magnetic arrangements can be provided to actuate the valve 1520. In other embodiments, the valve 1520 can be a mechanical valve rather than a magnetic valve. If a mechanical valve is used, the valve actuator 1415 may not be needed. For example, a mechanical valve can be actuated by the forces generated by the rotation of the sample vessel 1410 (e.g., centrifugal forces). Such a mechanical valve can employ a spring, such as a leaf spring, that is configured to be actuated by such forces.

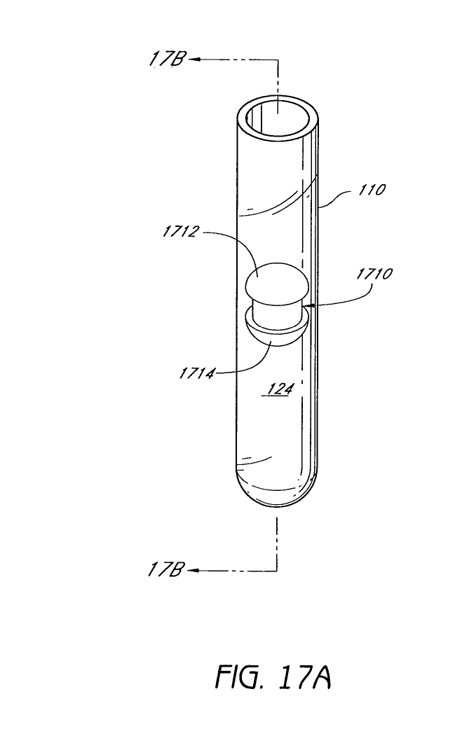

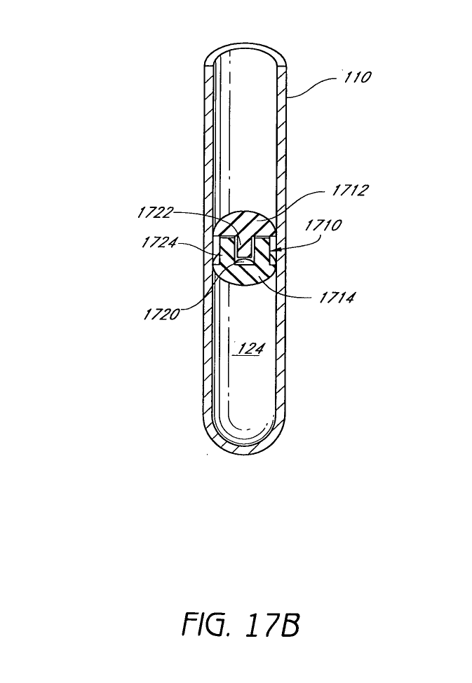

With reference to FIG. 17A, a test tube 110 is illustrated schematically, with a tilt valve 1710 located inside the chamber 124 of the test tube 110. The tilt valve has an upper valve portion 1712 and a lower valve portion 1714. Under certain conditions, the tilt valve can slide up and down inside the cavity 124 of the test tube 110 when the test tube is in a centrifuge such as the centrifuge 814. However, under other conditions, the tilt valve 1710 remains at a single vertical location within the cavity 124, even when under the influence of gravity.

The tilt valve 1710 can be manufactured separately from the test tube 110 and inserted into the test tube 110 at any time. In some embodiments, the tilt valve 1710 can be inserted into the test tube 110 in either orientation, that is, the upper valve portion 1712 and the lower valve portion 1714 can be inverted and interchange their relative positions. As illustrated, the lower valve portion 1714 has a rounded surface that can match to and/or conform with the rounded inner surface of the test tube cavity 124. Thus, when the tilt valve 1710 is located at the bottom of the cavity 124, there can be a flush engagement of the lower valve portion 1714 against the surface of the cavity 124. The upper valve portion has a similar rounded surface. In a preferred embodiment, the tilt valve 1710 comprises a biologically neutral material, such as silicone, for example. Furthermore, the tilt valve 1710 is preferably pliable and elastic to some degree. In particular, the tilt valve 1710 is more pliable than the plastic or glass that forms the test tube 110, in a preferred embodiment.

With reference to FIG. 17B, the test tube 110 is illustrated with the tilt valve 1710 inside the cavity 124. Each is illustrated in cross-section. As shown in FIG. 17B, the upper valve portion 1712 has an insert stem 1722, and the lower valve portion 1714 has a receiving stem 1724. In the central portion of the tilt valve 1710, in between the insert stem 1722 and the lower valve portion 1714, is a valve gap 1720. When the upper valve portion 1712 is fully inserted into the lower valve portion 1714, the insert stem 1722 may not reach all the way down into the valve gap 1720 even when fully inserted. The size of the valve gap 1720 depends on the relative lengths of the insert stem 1722 and the receiving stem 1724.

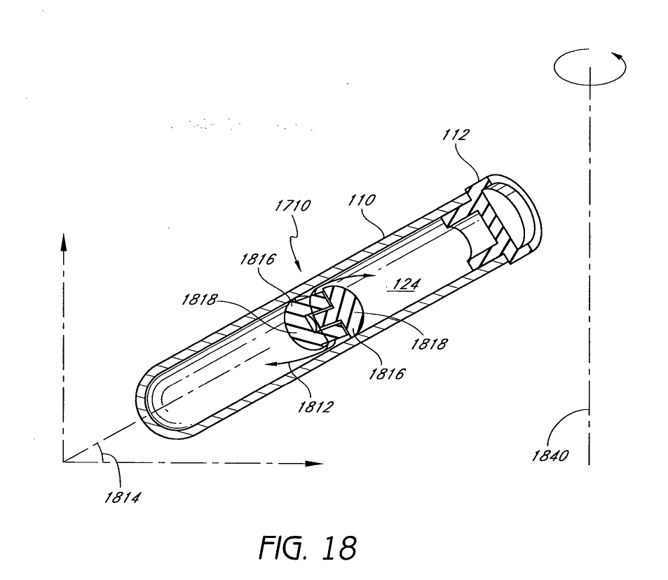

With reference to FIG. 18, the test tube 110 is illustrated in a tilted position, with cap 112 positioned on the test tube 110, and the tilt valve 1710 shown inside the cavity 124. This cross-sectional depiction shows a flow 1812 of fluid around the tilt valve 1710, which is in a tilted configuration. In particular, two contacting portions 1816 of the tilt valve 1710 are illustrated. The contacting portions 1816 are partially compressed against the inside walls of the test tube 110. The contacting portions 1816 are located at opposite ends of the tilt valve 1710. The contacting portions 1816 do not allow passage of fluid between the tilt valve 1710 and the sides of the insider cavity 124 of the test tube 110. In contrast, the flow 1812 of fluid passes around non-contacting portions 1818. In some embodiments, the compressability and resiliency of the tilt valve 1710 allows the contacting portions 1816 to be compressed and partially deformed. The deformation of contacting portions 1816 provides a passageway for the fluid flow 1812. As illustrated, the tilt valve is tilting, thus allowing fluid to pass around the tilt valve 1710.

As illustrated in FIG. 16, when a valve allows fluid to flow, and the valve is located within a test tube which is being spun in a centrifuge, for example, the relative masses of the fluid constituents within which the valve is bathed are accentuated. Thus, in FIG. 18, if the test tube 110 is being rotated about an axis 1840, as shown, the fluid constituents within 124 experience a centrifugal force inward toward the axis 1840. This force acts to accentuate the differences between the various masses of the particles that make up the fluid constituents. Thus, the slow pull of gravity can be enhanced and the settling process can be advanced at much greater pace than would otherwise be the case. As illustrated, the test tube 110 is at an angle 1814 with respect to the plane of the floor. The combination of the tilt angle 1814 and the different masses of the two portions of the tilt valve 1710 cause the tilt valve 1710 to tilt. The lower valve portion 1714 is more massive than the upper valve portion 1712. Thus, when the test tube 110 is being rotated rapidly, the difference between the upper valve portion 1712 and the lower valve portion 1714 is accentuated. This causes the tilt valve 1710 to tilt, and allows fluid to flow around the valve as shown by the flow arrow 1812.

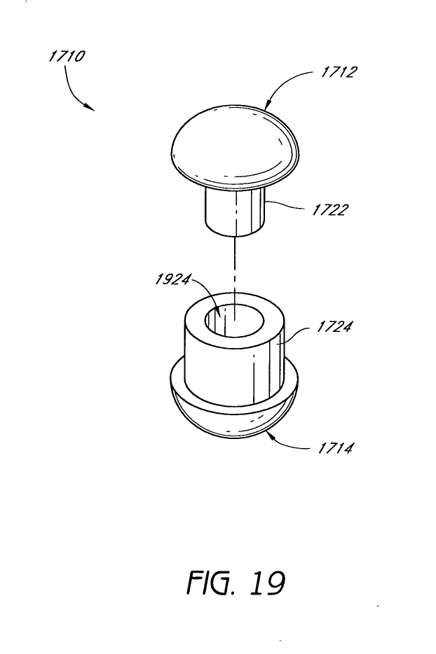

Referring now to FIG. 19, the tilt valve 1710 is illustrated with the upper valve portion 1712 and the lower valve portion 1714 separated, but oriented such that they can be readily recombined. The insert stem 1722 is illustrated over a receiving stem orifice 1924 in the receiving stem 1724. The insert stem 1722 can be reduced in length by snipping or cutting the end thereof, thus reducing the length of the insert stem 1722 and the mass of the upper valve portion 1712. By removing a portion of the insert stem 1722, the valve gap 1720 can be increased in size. Thus, when the upper valve portion 1712 is inserted into the receiving stem orifice 1924 to form a combined tilt valve 1710, the external geometry of the tilt valve 1710 can be the same as before the insert stem 1722 was reduced in length. Thus, the overall volume of the tilt valve 1710 can remain the same, even while reducing the overall mass of the tilt valve 1710. It may be desirable to alter the tilt valve 1720 in this way in order to tune or adjust the ratio between the mass of the tilt valve 1710 and the volume of the tilt valve 1710, thus tuning the valves buoyancy. For example, the valve may be heavier and less buoyant when the insert stem 1722 is longer and the valve gap 1720 is smaller. The tilt valve 1710 can be adjusted in this case to separate fluid constituents of a higher mass. However, if the tilt valve 1710 is required to separate two different fluid constituents having absolutely lower mass, the tilt valve 1710 may be adjusted as described above in order to make the tilt valve 1710 have a mass which falls in the desired range.

The design of the tilt valve 1710 provides many advantages when compared to the methods in the art for separating fluid constituents. For example, the silicone construction can provide a more permanent separation between blood constituents than is provided by other waxy separation portions. Furthermore, because the valve is preferably constructed from a biologically inert material, the valve does not react with or otherwise degrade or contaminate the fluid constituents that are also insider the test tube cavity 124. The tilt valve 1710 has the further advantage of being “tunable” to particular substances desired to be separated, as described above, and can thus be used in a variety of situations without requiring a new or different material to be used in formation of the valve. Thus, a single valve can be adjusted to have many mass to volume ratios. Furthermore, the valves mechanical shape can allow for efficient mass production, and simple and/or automated assembly. For example, the tilt valve 1710 can be inserted into test tubes by a robotic means. Another advantage of the tilt valve 1710 is the ability to remove it from a test tube 110 and use the use test tube 110 with no valve, if needed. Thus, test tubes 110 can be ordered separately and used independently of tilt valve 1710, and tilt valve 1710 can be ordered independently and provided in bulk, ready to be inserted into any appropriately sized test tube 1710. In a preferred embodiment, the tilt valve 1710 is proportioned to fit within a typical test tube 1710. Various sizes of tilt valve 1710 can be provided, each sized appropriately to fit the various sizes of test tubes 110. Indeed, the tilt valve 1710 can be used in various medical and/or biological or chemical containers, and needs not to be used only in test tubes. The tilt valve 1710 can function with varying shapes and sizes of containers.

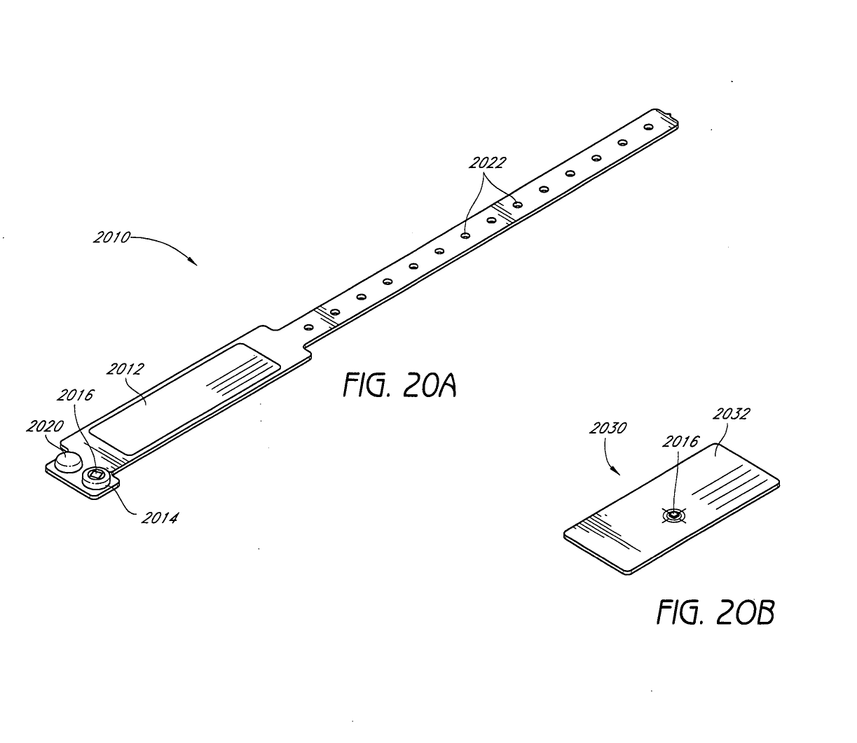

With reference to FIG. 20A, a data wristband 2010 is shown. The data wristband 2010 has a label 2012, a chip receptacle 2014, an RFID chip 2016, a fastener 2020, and fastener holes 2021. The data wristband 2010 can be formed from plastic to provide flexibility and strength, as well as longevity and affordable costs. The label 2012 can be adhered to the data wristband 2010 or it can comprise words or pictures that are printed directly on the surface of the data wristband 2010. The chip receptacle 2014 and fastener 2020 can be formed as integral portions of the data wristband 2010, being formed from the same plastic in a molding process, for example. The chip receptacle 2014 and fastener 2020 can also be separately formed and attached after formation of the data wristband 2010. In some embodiments, the data wristband 2010 can be formed in an extrusion or rolling process and cut using a template from a large thin sheet of plastic material. The fastener holes 2022 can be grilled, punched, or molded. The fastener holes 2022 need not be fully formed during the manufacturing process, and can be partially formed so that the material is weakened at a potential point where fastener hold can later be formed. For example, the fastener 2020 may have a protrusion (not shown) that can be used to poke out the already weakened material in a fastener hole 2022. The data wristband 2010 can be fastened together using other configurations that do not require fastener holes 2022. For example, a Velcro fastener can be used. Alternatively, snaps, buttons, zippers, chemical adhesives, latches, buckles, etc. can be used. In some embodiments, the wristband 2010 is difficult to remove so that once the wristband 2010 is in place, the data on the label 2012 or contained within the RFID chip 2016 is at least somewhat permanently associated with the person or entity to which the data wristband 2010 is fastened.

The RFID chip 2016 can be permanently associated with the data wristband 2010 by sealing the chip receptacle 2014 so that the RFID chip 2016 cannot be removed without damaging the RFID chip 2016. In some embodiments, a chip receptacle 2014 can be adhered to or otherwise associated with any wristband used by a healthcare provider to expand the data capabilities of that wristband or other labeling device.

With reference to FIG. 20B, a data card 2030 can have printed information 2032 as well as an RFID chip 2016. The data card 2030 can be formed like a credit card, or it can be extruded and stamped or cut from a template. The printed information 2032 can take the form of letters, codes, magnetic strips, pictures, hollow graphs, signature lines, etc. The RFID chip 2016 can be embedded in a slight hollow of the data card 2030 in order to allow the data card 2030 to maintain a slim profile. The RFID chip 2016 can also be laminated onto the surface of the data card 2030. Alternatively, the RFID chip 2016 can be embedded within a plastic resin that hardens with the RFID chip 2016 inside.

The data wristband 2010 and data card 2030 can be used in a variety of medical applications. The RFID chip 2016 can contain the type of data described above. For example, the RFID chip 2016 can include diagnosis, identification, prescription, dosage, sample processing, medical history, allergy, insurance, and/or administrative data, etc. The data wristband 2010 can be fastened to a patient in a hospital and used to track the patient's medical data. For example, the nurse attending the patient can obtain data from the data wristband 2010 in order to determine the medical procedure to follow with respect to that patient. For example, dosages and/or prescriptions can be determined in the absence of a doctor, if the data has already been entered for dosages or prescriptions onto the RFID chip 2016. Alternatively, the data wristband 2010 can be used to track the movements of a patient within a medical or other institution. For example, if the patient is not allowed to leave the patient's bed and/or hospital room, because of adverse health effects, for example, the RFID chip 2016 can help allow the healthcare or other institution to know if the patient attempts to leave a bed and/or room. The data wristband 2010 can also be used to record the times, circumstances, etc. of any medical treatments that are administered to a patient. Furthermore, a healthcare professional can record observations about the condition of a patient and the time and/or circumstances of that medical authorization can be tracked. In some embodiments, the data stored on a data wristband 2010, and/or data card 2030, can correspond to the data in one or more test tubes on RFID chips in those tubes, as discussed above. For example, medical specimen test results can be stored on a data wristband 2010 or data card 2030.

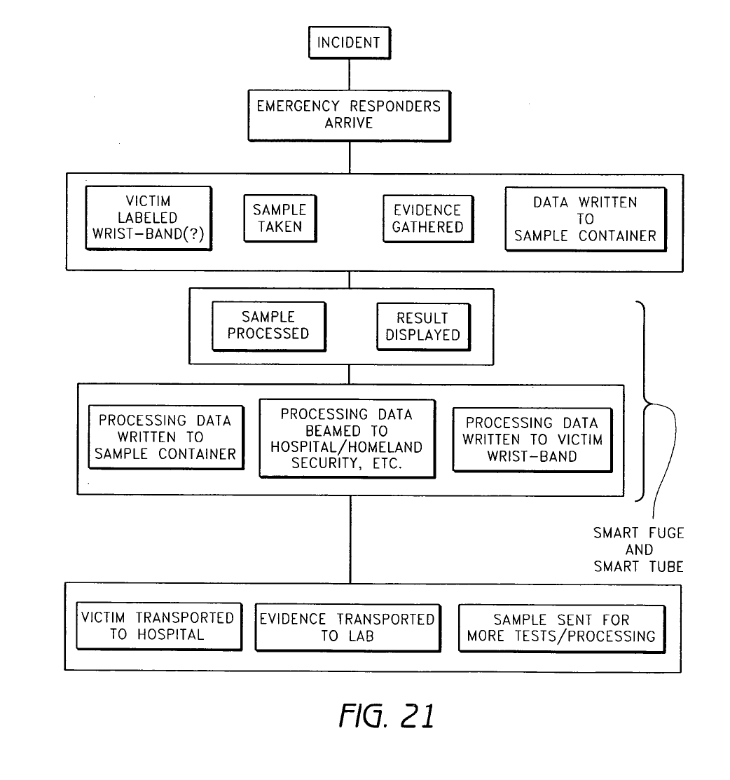

With reference to FIG. 21, a flowchart shows examples of steps that can be performed in gathering medical specimens and data in an emergency setting, and/or testing the specimens and data and storing information relating to this process. In particular, in a first stage 2112, an emergency or medical incident can occur. In a second stage 2116, emergency responders can arrive at the scene of the incident. Alternatively, laypersons can arrive at the scene, but be in contact with emergency personnel by telephone, for example. In a third stage 2120, a victim can be labeled or otherwise identified, using a wristband such as that illustrated in FIG. 20A, for example. Information relating to the victims identity and/or symptoms can be recorded as well as data relating to the site of the incident and identities of emergency responders and other, for example. The third stage 2120 can also include taking samples from a victim, for example, blood can be drawn and/or other biological substances can be obtained. The third stage 2120 can also include gathering evidence for a later investigation or trial, for example. The third stage 2120 can also include writing data to a sample container, such as the sample container illustrated in FIG. 1. The sample container a test tube, an enclosable box, a plastic sack, etc. The emergency responders can collect data at the scene of the incident in the form of physical measurements, photographs, verbal testimony from witnesses, fluid samples, air samples, soil samples, water samples, chemical samples, etc. In a fourth stage, any of the samples taken can be processed and the results of that processing can be displayed. The portable devices depicted in FIGS. 8A and 13 can be especially helpful in processing samples and displaying results, for example. In a fifth stage 2128, process data can be written to a sample container. Subsequently or concurrently, processed data can be transmitted to a healthcare facility, an emergency communications hub, the Center for Disease Control, a hazmat mobile unit, a satellite receiver, a web interface, etc. Processed data can also be written to and recorded on a data wristband that has been placed on a victim. In a sixth stage 2132, a victim can be transported to a hospital, evidence can be transported to a lab, and/or sample can be sent elsewhere for more tests and/or processing. The data that has been recorded in earlier stages can remain with the electronic device onto which it was recorded for later use in further stages.

Although the present inventions have been described in terms of certain preferred embodiments, other embodiments apparent to those of ordinary skill in the art also are within the scope of the inventions. Thus, various changes and modifications may be made without departing from the spirit and scope of the inventions. Moreover, not all of the features, aspects and advantages are necessarily required to practice the present inventions.

What is claimed is:

1. A system for tracking a sample comprising:
a test tube having a cylindrical portion and a rounded bottom portion, the test tube comprising a top end configured for allowing sample insertion into an interior cavity and a bottom end having a chamber separated from the interior cavity, the chamber closed with a cap that forms a rounded end portion of the outer contour of the rounded bottom portion;
a radio-frequency identification (RFID) chip within said chamber; and
a read-write device having a receptacle for said test tube and a read-write element, the receptacle configured to position the RFID chip within range of the read-write element.

2. The system of claim 1, further comprising a buffer region between the interior cavity and the chamber, the buffer region formed from the same material as the rest of the test tube.

3. The system of claim 1, wherein the RFID chip is suspended within a hardened resin within the chamber.

4. The system of claim 1, wherein the cap seals the chamber.

5. The system of claim 1, wherein the RFID chip is programmed with locked data fields.

6. The system of claim 1, wherein the RFID chip comprises an outer protective lamination layer.

7. A method of manufacturing a sample container in the shape of a test tube, the method comprising:
providing a plastic material;
forming the plastic material in the general shape of a standard test tube with an open end that opens into a sample-containing portion, a closed end, and a chamber portion at the closed end, the chamber portion not open to the sample-containing portion;
inserting an RFID chip into the chamber portion; and
covering the chamber portion with a plastic cover that provides a rounded bottom end on the test tube.

8. The method of claim 7, further comprising laminating the RFID chip with a protective layer.

9. The method of claim 7, further comprising surrounding the RFID chip with a liquid substance.

10. The method of claim 9, further comprising allowing the liquid substance to harden surrounding the RFID chip.

11. The method of claim 7, wherein sealing the chamber portion closed comprises heating the plastic material.

12. A method of gathering information related to a medical specimen, the method comprising:
providing a portable device that comprises a centrifuge and a computer;
entering victim and/or incident information into the portable device;
obtaining a biological sample from the victim and placing the sample in a sample container comprising an electronic data storage device;
processing the sample with the portable device; and
using the portable device to write electronic data to the electronic data storage device.

13. The method of claim 12, wherein using the portable device to write electronic data to the electronic data storage device comprises writing data that relates to the results of processing the sample.

14. The method of claim 12, wherein using the portable device to write electronic data to the electronic data storage device comprises writing data that relates to the identity of the victim.

15. The method of claim 12, further comprising wirelessly transmitting the electronic data to a remote location from the portable device.

16. The method of claim 15, wherein wirelessly transmitting the electronic data to a remote location from the portable device further comprises transmitting the electronic data to a hospital.

17. The method of claim 15, wherein wirelessly transmitting the electronic data to a remote location from the portable device further comprises transmitting the electronic data to a government agency.

18. The method of claim 15, wherein wirelessly transmitting the electronic data to a remote location from the portable device further comprises transmitting the electronic data to a hospital.

19. The method of claim 13, further comprising wirelessly transmitting the electronic data to a storage device associated with the victim.

20. The method of claim 19, wherein the storage device comprises a wristband having electronic data storage.

21. A device for processing samples comprising:
a computer having a user interface, the user interface comprising a data input device and a data projection device;
a centrifuge;
a sample holder; and
a wireless signal transmission/reception module.

22. The device of claim 21, further comprising a test module.

23. The device of claim 22, wherein the test module comprises a chemical assay kit.

24. The device of claim 21, wherein the sample processor further comprises a centrifuge lid.

25. The device of claim 21, wherein the sample processor comprises a centrifuge configured to tilt the sample containers such that their long axes are not generally aligned with the plane of rotation.

26. The device of claim 21, wherein the sample holder is configured to receive a test tube.

27. The device of claim 26, wherein the sample holder is further configured to position the bottom of the test tube near a data read/write device.

28. The device of claim 21, wherein the data input device comprises a keypad.

29. The device of claim 21, wherein the data projection device comprises a computer screen.

30. The device of claim 21, wherein the data projection device comprises a speaker.

31. The device of claim 21, wherein the data projection device and the data input device each comprise the same computer screen.

32. The device of claim 21, further comprising a portable carrying case with a handle that contains the computer, the sample processor, the sample holder, and the wireless signal transmission/reception module.

33. The device of claim 32, wherein the computer, sample processor, and sample holder are built in to the portable carrying case.

34. The device of claim 33, wherein the data input device comprises a keypad and the data projection device comprises a computer screen, and wherein the keypad and the computer screen are configured to furtherseparate from each other when the portable carrying case is opened.

35. A tilt valve comprising:
a first valve portion with an insert stem having a first length and a first contacting portion that is wider than the insert stem; and
a second valve portion with a receiving stem having a second length, the second length greater than or equal to the first length, and a second contacting portion having approximately the same width as the first contacting portion.

36. The tilt valve of claim 35, wherein the first and second valve portions are formed from a biologically neutral material.

37. The tilt valve of claim 36, wherein the first and second valve portions are formed from silicone.

38. The tilt valve of claim 35, wherein each contacting portion has a rounded surface that corresponds generally to the inner shape of the bottom of a standard test tube.

39. A method of separating fluid components with a tilt valve, the method comprising:
providing a test tube having side walls;
providing a fluid with components of different densities within the test tube;
providing a tilt valve within the test tube;
providing a centrifuge;
causing the tilt valve to assume an open position by rotating the test tube in the centrifuge.

40. The method of claim 39, further comprising causing the tilt valve to move from an open position to a closed position by slowing or stopping the rotation of the centrifuge.

41. The method of claim 39, further comprising allowing the centrifuge to rotate long enough to allow the fluid components of different densities to separate.

42. The method of claim 39, further comprising selecting the density of the tilt valve.

43. The method of claim 42, wherein selecting the density of the tilt valve comprises removing a portion of the tilt valve to increase the size of a valve gap within the tilt valve.

44. The method of claim 42, wherein providing a tilt valve further comprises providing an insert stem and a receiving stem, and wherein selecting the density of the tilt valve comprises sliding the insert stem farther into or farther out of the receiving stem.

45. The method of claim 39, wherein causing the tilt valve to assume an open position further comprises compressing at least two contacting portions against the side walls of the test tube.
